(19) United States
(12) Patent Application Publication
(10) Pub. No.: US 2026/0252046 A1
(43) Pub. Date: Aug. 27, 2026

(54) OPERATION DEVIATION ASSESSMENT FOR INDUSTRIAL PROCESSES

(71) Applicant: Honeywell International Inc., Charlotte, NC (US)

(72) Inventors: Praveen Tayal, Hyderabad (IN); Farzan Ashfaque, Calicut (IN); Sharan Nagarajan, Bangalore (IN); Satrujeet Dey, Bangalore (IN)

(21) Appl. No.: 19/058,037

(22) Filed: Feb. 20, 2025

(51) Int. Cl. G05B 13/04

(52) U.S. Cl. CPC G05B 13/041

(57) ABSTRACT

Techniques for assessment of an operation linked with the industrial process environment are disclosed. An assessment request is received for an operation having variables and a performance indicator linked therewith. The request is to predict lead time to deviation of the performance indicator from a threshold. A computational model, trained with historical time-series data, is executed to predict lead time. The model relates segments, indicating variable’s behavior or value patterns, to temporal buckets indicating lead times. The model identifies a segment corresponding to recent variable behavior and determines a linked temporal bucket. Further, a risk indicator, quantitatively indicating the risk associated with the deviation, is also determined. At least one of the lead time and the risk indicator is then rendered. The disclosed techniques enable proactive management of industrial processes by predicting lead time to deviations and risks associated with them before they occur.

### BACKGROUND

An industrial process environment may include one or more processing facilities where a series of industrial processes or operations are performed. Typically, the processing facilities are equipped with solutions and systems to ensure that industrial operations are executed in a controlled and optimal manner. For instance, such solutions aim to monitor various variables and indicators associated with the operations for detecting substantial deviations. Some of the solutions may also predict the values of the variables and/or indicators. However, such solutions often fall short in providing comprehensive insights that may be critical, considering the complex interplay of multiple variables.

### BRIEF DESCRIPTION OF DRAWINGS

The detailed description is described with reference to the accompanying figures. It should be noted that the description and figures are merely examples of the present subject matter and are not meant to represent the subject matter itself.

FIGS. 1A to 1C illustrate a block diagram of a computing environment comprising a system, according to an example implementation of the present subject matter.

FIG. 2 illustrates an exemplary pattern of values for different variables correlated with an operation linked with an industrial process environment, according to one example implementation of the present subject matter.

FIG. 3 illustrates an exemplary pattern of values for a performance indicator linked with the operation, according to one example implementation of the present subject matter.

FIG. 4 illustrates a block diagram of a system, according to one example implementation of the present subject matter.

FIG. 5 illustrates a block diagram of a computing environment comprising the system, according to another example implementation of the present subject matter.

FIG. 6 illustrates a historical time-series data indicating the pattern of values of the performance indicator, according to one example implementation of the present subject matter.

FIGS. 7A to 7B illustrate a relationship between a plurality of segments and a plurality of temporal buckets, according to one example implementation of the present subject matter.

FIGS. 8A to 8B illustrate a graphical user interface, according to one example implementation of the present subject matter.

FIG. 9 illustrates a graphical user interface indicating a risk indicator determined for each variable in a set of variables, according to one example implementation of the present subject matter.

FIG. 10 illustrates a block diagram of an exemplary method for assessment of an operation linked with the industrial process environment, according to one example implementation of the present subject matter.

FIG. 11 illustrates a non-transitory computer-readable medium for assessment of an operation linked with the industrial process environment, in accordance with an example of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

With advancements in technology, various solutions have been developed for monitoring the operations linked with processing facilities. Generally, industrial process environments rely heavily on solutions and systems designed for monitoring and maintaining various variables and indicators to ensure optimal execution of industrial operations or processes. Such solutions may be specialized for monitoring various variables, such as temperature, pressure, quality, flow rates, composition, input of material, and the like related to the operations. The processing facilities may also be equipped with various devices, for example, sensors, to continuously measure real-time values for different parameters or variables related to the operations or processes. The variables or real-time data are generally utilized to determine different aspects or insights related to the operations. For instance, the variables may be processed to determine a process function or indicator that may provide insights about the operations. The insights may be related to, for example, the performance of the operations, future behaviors, the overall cost of operation, operational efficiency, losses, and the like. In one example, such indicators may be Key Performance Indicators (KPIs) indicating information about one or more operations of the industrial process environment.

While some of the solutions monitor the variables and indicators for detecting unwanted deviations, other advanced solutions predict the value of indicators or the likelihood of occurrence of an unwanted deviation. Such solutions also alert operators, for example, when an indicator deviates from a predefined threshold. However, such traditional solutions or systems typically fail to provide other crucial insights about the operations. For example, notifications or alerts are only provided upon occurrence of a deviation, leaving operators and managers in a reactive rather than proactive stance, thereby leaving little time for assessment and preventive action. Further, balancing the need for early warnings with the desire to minimize false alarms presents another technical hurdle. For example, systems that are too sensitive may generate excessive and unnecessary alerts, leading to increased resource utilization in the generation of false alerts and causing alert fatigue, thereby reducing operator’s responsiveness.

Further, the typical solutions fail in determining and providing any temporal information that may dynamically indicate and update a time or duration remaining before a deviation is expected to occur, along with the potential contributor’s changing behavior in the forward time scale. Such limitations significantly hamper the ability of operators to prioritize their responses and take appropriate actions, for example, allocate resources effectively, as they lack a clear understanding of the urgency associated with each predicted deviation. Such limitations can also result in a cascade of issues including operational inefficiencies, quality control problems, and in severe cases, safety concerns. Thus, a significant challenge exists in providing actionable insights that allow operators and engineers to understand not just if a deviation might occur, but when it is most likely to happen.

The problem is further exacerbated by the increasing complexity of industrial processes and the vast amount of data generated. For example, in a complex and interconnected industrial process environment, there may be an intricate interplay of numerous variables that influence overall performance in unpredictable ways. Consequently, identifying the most critical variables and their potential impacts on the indicators becomes an increasingly challenging task. Thus, comprehensively understanding the underlying causes of deviations and accurately assessing the associated risks becomes challenging in such complex landscapes. Further, many existing solutions struggle to effectively integrate historical data with real-time monitoring, missing crucial patterns that could indicate impending issues. This integration is further complicated by the sheer volume and velocity of data generated in modern industrial environments, which can overwhelm traditional solutions or methods.

Another significant challenge is the difficulty in quantifying and effectively communicating risk levels associated with the deviations. Without a clear, data-driven understanding of the potential consequences and their likelihood, decision-makers often find themselves in a quandary when it comes to prioritizing their responses. This ambiguity can lead to a misallocation of resources, where minor issues may receive disproportionate attention while more critical problems develop unnoticed, potentially resulting in significant operational disruptions or safety hazards.

Moreover, the challenge of effectively visualizing and presenting complex, multidimensional data in a manner that facilitates quick understanding and action is often overlooked. Many existing systems struggle to convert their analytical insights into clear, actionable information that can be readily understood and acted upon by users or operators who may not have deep expertise. Such communication gaps can lead to delays in response times and missed opportunities for pre-emptive action.

Thus, more sophisticated predictive systems or solutions are required that can address these multifaceted challenges, provide accurate warnings of potential deviations along with offering insights into the expected timing of such events and risks associated with such events, and be able to handle the complexity and scale of modern industrial data while providing insights that are both profound and accessible.

The present subject matter discloses techniques for assessing operations linked with an industrial process environment. In one example, the assessment may be for determining a probable lead time indicating a duration to a probable deviation of a performance indicator associated with the operation. The present subject matter also discloses techniques for determining a risk associated with the probable deviation.

According to one example, an assessment request may be received for an operation linked with an industrial process environment. The operation may have associated therewith a plurality of variables and a performance indicator. The variables may include, but are not limited to, values or data obtained from sensors and devices located in the industrial process environment. Further, the performance indicator may be derived based on these underlying variables and may represent, for example, a key performance indicator (KPI) indicating one or more aspects about the operation, such as efficiency, quality, productivity, or safety metrics.

Upon receiving the assessment request, a computational model, capable of predicting the probable lead time, may be executed. The computational model may be trained using historical time-series data, which indicates patterns of values for a set of variables identified from among the plurality of variables associated with the operation. This historical time-series data may comprise continuous values of different variables linked with the operation and collected over a period of time, such as weeks, months, or even years. In some cases, the historical time-series data may include the pattern of values of only those variables that have been identified, from amongst the plurality of variables, based on their causal effect or impact on the performance indicator. The identification may involve, for example, determining the most relevant variables affecting the performance indicator.

Further, the computational model may be supervisingly modelled or trained by defining a relationship between segments of the historical time-series data and temporal buckets indicating probable lead times to deviations. This process may involve determining a plurality of segments or patches from the pattern of values corresponding to each variable in the set of variables. Each segment may represent a window or patch of the pattern of values for all the variables in the set of variables. Thus, each of the segments may be indicative of a pattern or behavior of the values within that patch or segment of the pattern of values. Some of these patches may comprise a series of the pattern of values of the variables that caused or led the performance indicator to deviate from, or at least approach towards, a historical threshold value.

Further, each temporal bucket may indicate a probable lead time to the deviation of the performance indicator. In one example, each temporal bucket may indicate a unique duration to the deviation. For example, one temporal bucket may indicate that 5 to 6 hours may probably be remaining to the deviation of the performance indicator, while another temporal bucket may indicate that 3 to 4 hours may probably be remaining. Similarly, multiple temporal buckets may be defined, each indicating a different duration to the probable deviation.

In one example, linking of segments with temporal buckets may be based on the degree of proximity of the performance indicator to the historical threshold value. As the performance indicator may be derived based on the variables, the segments indicating patterns of values of each of the variables may be indicative of values of the performance indicator. Thus, based on the segments, the degree of proximity of the performance indicator to the historical threshold value may be ascertained. Accordingly, a temporal bucket may be linked with each of the segments. For instance, a segment, comprising a series or section of the pattern of values of each variable in the set of variables, causing the performance indicator to be proximate to the probable deviation may be linked with a temporal bucket indicating increased temporal proximity or closeness to the probable deviation. Conversely, another segment, comprising a section or series of pattern of values causing the performance indicator to be comparatively distanced from the probable deviation, may be linked with another temporal bucket that may be temporally distanced from the probable deviation. Thus, each of the segments may be linked with a temporal bucket, thereby indicating temporal proximity to the probable deviation of the performance indicator for a corresponding section or segment of the pattern of values of the variables. Further, as each of the segments may be indicative of a pattern or behavior of the pattern of values, modelling or training based on relationships between the segments and the temporal buckets may enable the computational model to determine temporal buckets based on behavior of the pattern of values of the variables.

Once the computational model has been trained and an assessment request is received, for instance at time “t”, the model may be executed to analyze a trend of values of each variable in the set of variables recorded immediately before time “t”. The trend of values may include patterns of values that have been recorded recently or immediately prior to reception of the assessment request. For example, when an assessment request is received from an operator, the computational model may obtain or retrieve the trend of values, for each variable in the set of variables, that have been recorded immediately before reception of the request. In one example, the trend of values may be time-series data and may indicate a pattern or behavior of values of each variable in the set of variables over a period of time before reception of the request.

The computational model may then identify a segment, from amongst the plurality of segments, corresponding to the behavior of each variable in the set of variables, indicated by the trend of values of the set of variables. In one example, this identification may involve, for example, pattern matching or similarity analysis to find the segment that most closely resembles the current trend of values. In another example, the computational model may analyze the values of each variable in the set of variables at time “t”. The values at time “t”, because of their time-series nature, may have dependency on values recorded previously or prior to time “t”. Thus, the values recorded previously or prior to time “t” may have an impact on the values at time “t” due to the sequential nature of timeseries. The computational model may then identify a segment that may correspond or match with the behavior indicated by the values at the time “t”. Thus, the computational model may identify a segment, which indicates pattern or behavior of values, that probably matches with the behavior indicated by the values of the variables at time “t”. Once the matching segment is identified, the temporal bucket linked with that segment may be determined.

After determining the temporal bucket, the temporal bucket may be rendered to indicate the probable lead time to the probable deviation. In one example, the lead time may be dynamically updated as the operation progresses and/or the trend of values is updated. Also, in one example, the temporal bucket, and thus the lead time, may be re-determined based on real-time changes in the trend of values of the set of variables, allowing for continuous monitoring and assessment of the operation.

In addition to determining the probable lead time, a risk indicator may also be determined. This risk indicator, in one example, may be an aggregate score quantitatively indicating the probable risk associated with the probable deviation of the performance indicator. The risk indicator may be computed based on multiple factors determined for all variables in the set of variables. In one example, the risk indicator may be computed based on an occurrence indicator determined for each variable in the set of variables, indicating how often that variable has been identified as a probable cause of deviations; a weightage indicator indicating each variable's contribution in causing the deviation of the historical performance indicator; the determined temporal bucket indicating the probable lead time; and a deviation indicator indicating an amount of drift in values of that variable based on the trend of values. In one example, the occurrence indication and the weightage indication may be derived based on the historical time-series data. Based on the risk indicator, one or more alerts may be generated to warn about the probable deviation of the performance indicator. In one example, the risk indicator may be dynamically updated with a change in the deviation indicator and as the probable lead time progresses towards the occurrence of the probable deviation, providing real-time risk assessment for the operation.

Further, to effectively convey these determinations, one or more graphical user interfaces may be rendered. These interfaces may display, in one example, the probable lead time and the risk indicators or scores for each variable. Additionally, a risk profile, determined based on the risk indicator, may also be rendered through the graphical user interface(s). This visual representation may include charts, graphs, or other visual elements to help operators quickly understand the current situation and potential risks.

As an example of application, such as in an oil refinery, variables such as temperature, pressure, and flow rate linked with an operation may be monitored. The performance indicator, for example, could be a KPI indicating quality of the refined product. Upon determination that a pattern in these variables appears to be similar in behavior to historical patterns that led to quality issues, a prediction may be made to indicate how soon a quality deviation might occur. Such information or insight may allow operators to take preventive action before the deviation occurs. Also, an indication of the risk associated with the deviation may alert the operator about the severity of the deviation. The operator may accordingly ascertain whether a preventive action is actually necessary.

The indication of the risk associated with the deviation may further alert the operator about the severity of the potential deviation. This risk assessment may help the operator determine whether immediate preventive action is necessary or if the situation can be monitored for further developments. By providing both lead time predictions and risk assessment, more informed decision-making in complex industrial environments becomes possible.

The present subject matter provides several technical advantages for assessment of one or more operations in industrial process environments. For example, the present subject matter discloses enhanced predictive capabilities that provide more insights apart from detecting deviations. The present subject matter discloses predicting lead times indicating when the deviations are likely to occur. This is achieved, in one example, through a sophisticated computational model trained on historical time-series data, which can analyze current trends, behaviors, and identify patterns that may lead to deviations. This predictive approach allows operators to shift from reactive to proactive management, significantly improving operational efficiency and reducing the risk of unexpected disruptions.

A crucial technical advantage is the system's ability to provide and continuously update probable lead times to deviations. By linking historical data segments to temporal buckets, the system can offer real-time estimates of how much time remains before a potential deviation occurs. This temporal information is invaluable for prioritizing responses and allocating resources effectively, addressing a significant gap in existing solutions

Further, the present subject matter discloses dynamic lead time estimation, i.e., an ability to provide and continuously update probable lead times to deviations. By linking historical data segments to temporal buckets, real-time estimations may be performed to determine and indicate how much time probably remains before a potential deviation occurs. This temporal information is invaluable for prioritizing responses and allocating resources effectively, addressing a significant gap in existing solutions.

Further, by comprehensive risk assessment, risks associated with deviations are quantified and communicated. By computing a risk indicator based on multiple factors such as occurrence frequency, variable weightage, lead time, and deviation magnitude, the present subject matter provides a nuanced understanding of the potential consequences and necessity of any precautionary action. Such a multi-faceted risk assessment enables more informed decision-making and helps in prioritizing actions based on the severity and likelihood of issues.

Furthermore, the computational model's training process, which involves analyzing historical time-series data and identifying causal relationships between variables and performance indicators, may allow for mapping or coverage of complex relationships between multiple underlying variables and their causal effects on the performance indicator. Additionally, by rendering graphical user interfaces that display lead times, risk indicators, and risk profiles, sophisticated analytical insights are converted into clear, actionable information. This visual approach significantly enhances operator’s ability to quickly grasp the current situation and potential risks, facilitating faster and more effective assessment of the operations and decision-making.

The present subject matter may also offer scalability and complexity management. By focusing on a set of identified variables with the most significant impact on performance indicators, instead of vast amount of data generated in modern industrial environments, a considerable volume of important data may be efficiently processed and analyzed, leading to efficient utilization of computing resources and reducing processing complexities. This approach also allows for comprehensive monitoring of complex, interconnected industrial processes while maintaining computational efficiency.

Further, the present subject matter discloses bridging the gap between historical analysis and real-time monitoring. By continuously comparing current trends with historical patterns, subtle indicators of impending issues, that might be missed by traditional monitoring solutions, may be identified. This integration allows for a more holistic, real-time, and accurate assessment of operational risks and performance.

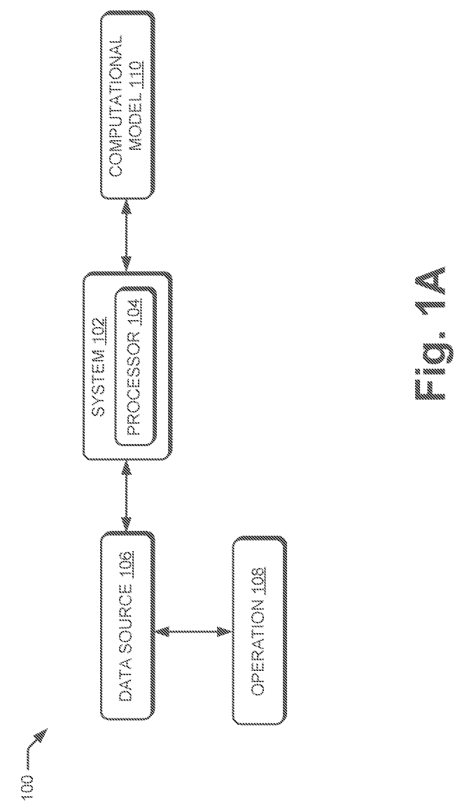

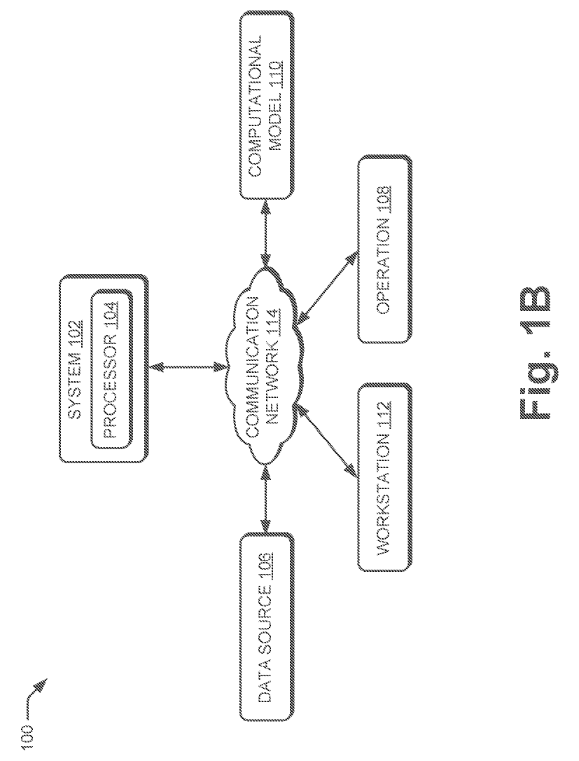

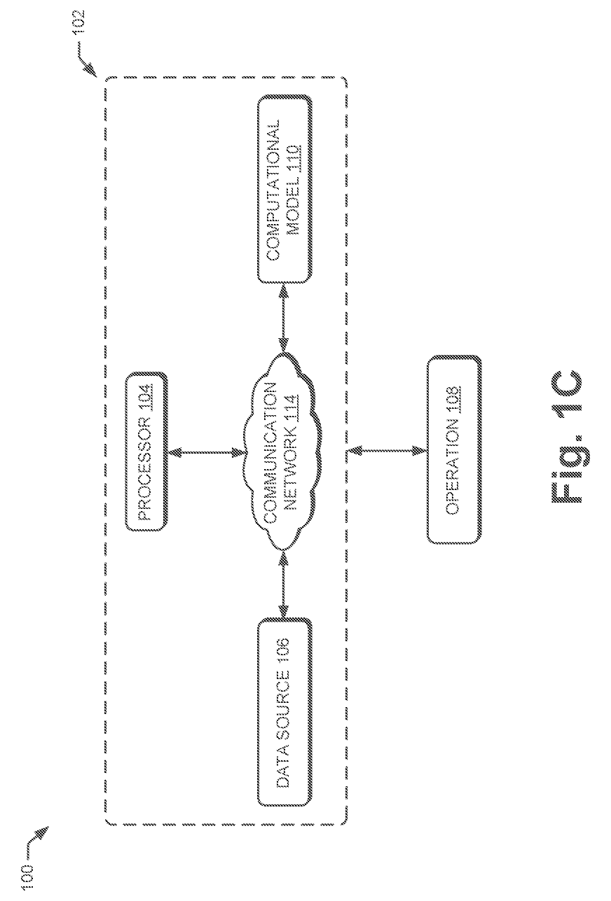

The above techniques are further described with reference to FIGS. 1A to 11. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A to 1C illustrate a block diagram of a computing environment 100 comprising a system 102, according to an example implementation of the present subject matter. FIGS. 1A to 1C will be discussed in conjunction with each other.

The computing environment 100 may be any computing environment comprising the system 102. In one example, the computing environment 100 may be an industrial process environment having one or more processing facilities associated therewith. The processing facilities may be, in one example, units where raw materials may be processed into finished products through a series of chemical, physical, mechanical, or biological operations. Examples of processing facilities may include, but are not limited to, manufacturing units, assembling units, testing units, and material processing units or plants. The processing facilities could also be units related to different sectors. For example, the processing facilities may be related to oil and gas, petrochemicals, pharmaceuticals, food and beverage, chemical processing, metallurgical engineering, content delivery network, data management, data processing, software development and/or management, and automobile sector. Other examples of the processing facilities may also be possible.

Further, the system 102 may be capable of assessing probable deviations of operations linked with the industrial process environment. The assessment may comprise, in one example, determining a probable lead time, indicating a duration, to occurrence of a probable deviation of a performance indicator associated with an operation. The system 102 may also be capable of assessing a probable risk associated with the deviation, as will be discussed. In one example, the system 102 may also be capable of cause rendering of one or more graphical user interfaces to indicate the probable lead time and risk associated with the probable deviation.

In one example, the system 102 may be implemented in the computing environment 100 as a set of one or more hardware devices or modules. For example, the system 102 may be implemented as a set of one or more hardware devices, comprising at least a processor 104. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, Artificial Intelligence (AI) based processors, machine learning-based processors, deep learning-based processors, system-on-chip (SOC), processing circuitries including one or more modules or engines, and/or any other devices that manipulate signals and data based on computer-readable instructions.

In another example, the system 102 may be implemented as a set of computer-executable instructions. In this example, the processor 104 may be an engine capable of executing the set of computer-executable instructions that may assess operations linked with the industrial process environment, and data associated therewith, for determining the probable lead time and risk associated with deviations. Examples of the system 102, according to this example, may include, but are not limited to, software applications, cloud-based platforms, and Software as a Service (SaaS). In yet another example, the system 102 may be implemented as a combination of the one or more hardware devices and the set of computer-executable instructions. In this example, the set of computer-executable instructions may be executed by the processor 104 to assess operations linked with the industrial process environment, and the data associated therewith, for determining the probable lead time and risk associated with deviations.

Further, in one example, the computing environment 100 may include a data source 106. The data source 106 may be operationally linked with the one or more operations of the industrial process environment and may be capable of generating data about the one or more operations. The data may be indicative of, for example, values corresponding to one or more variables correlated or associated with the one or more operations, such as an operation 108, of the industrial process environment. That is, the data generated by the data source 106 may indicate values of the one or more variables. In another example, values for the one or more variables may be derived from data generated by the data source 106.

In one example, the one or more variables may be correlated with input and/or output characteristics of the one or more operations. For example, a variable may be temperature and the data generated by the data source 106 may be indicative values of the temperature. Other examples of the variables may include, but are not limited to, flow rate, pressure, size of data, quality, composition, input and/or output of material, and the like related to the operation 108. Thus, the data source 106 may be capable of generating data indicating values of the one or more variables, where the variables may correspond to different characteristics of the one or more operations.

In one example, the data source 106 may include one or more devices that may be operationally linked with the one or more operations of the industrial process environment. Such devices, in one example, may be capable of generating data corresponding to the one or more variables. Examples of the devices may include, but are not limited to, sensors, meters, detectors, valves, data loggers, gauges, networking devices, servers, gateways, access points, computing devices, and telemetry devices. In another example, the data source 106 may be one or more devices or machines that may itself be involved in the one or more operations and may be capable of generating data for the one or more operations.

In one example, the data source 106 may also include a datastore to store the data indicating values corresponding to the one or more variables. For example, the datastore may be operationally linked with one or more devices, such as sensors, associated with the one or more operations and may store data, indicating values for the variables, being generated by the devices. In one example, the datastore may receive and store the data either continuously or at predefined intervals. For example, the datastore may continuously store the data being generated by the sensors in real-time or during the implementation of the operation 108.

In one example, the data source 106 may generate and/or store the data in form of data logs or time-series data, where data may have additional temporal details associated therewith. For example, the time-series data may be a collection of data points or observations recorded sequentially or chronologically. Each data point may, in one example, consist of a timestamp and a corresponding value that represents a measurement at that specific time. For example, a sensor may record the temperature of a furnace involved in the operation 108 at one-minute intervals. In the above example, the temperature may be a variable and the data points or recorded values may correspond to values of the temperature variable. In one example, such values, when recorded over a period of time, may form or indicate a pattern or behavior of values for the variable over the period of time. Further, in time-series data, the data point may not be independent. That is, the value at a given time may depend on past values.

The datastore may also store, in one example, derived data or functions, interchangeably referred to as performance indicators. Such performance indicators may be derived by processing the values of the variables. For example, the datastore may record a performance indicator, associated with the operation 108, computed based on values of the one or more variables correlated with the operation 108. These performance indicators may be complex functions or simple calculations that combine multiple variables to produce a meaningful metric. Such derived information or performance indicators may provide additional insights or metrics beyond the raw variables. Examples of such performance indicators may include, but are not limited to, efficiency metrics, statistical measures, key performance indicators (KPIs), composite scores, time-based derivatives, aggregated data that summarizes the variables, and data indicating amount, quality, and/or quantity of the output generated by the performance of the one or more operations.

The datastore may continuously store updated values of the performance indicators, computed based on new data for variables, allowing for real-time monitoring and analysis. By storing values corresponding to the variables and the derived performance indicators linked with the operations, the datastore may provide a comprehensive view of the overall operations linked with the industrial process environment, enabling more sophisticated analysis, reporting, and decision-making capabilities. In one example, the datastore may store data or information, comprising values of the variables and the performance indicators linked with the one or more operations, in a relation or tabular format, to clearly indicate what values of the variables and the performance indicators are linked with each of the operations from amongst multiple operations of the industrial process environment.

Similarly, the datastore may also store time-series data for the performance indicator linked with the operation 108, and derived based on the one or more variables correlated with the operation 108. FIG. 3 illustrates an exemplary pattern 300 of values for a performance indicator linked with the operation 108, according to one example implementation of the present subject matter. The time-series data may indicate values (for example, on Y-axis) of the performance indicator derived, over a period of time (as indicated by the “TIME” axis), based on the one or more variables linked with the operation 108. The time-series data may thus be indicative of a trend or pattern of values of the performance indicator 302 linked with the operation 108.

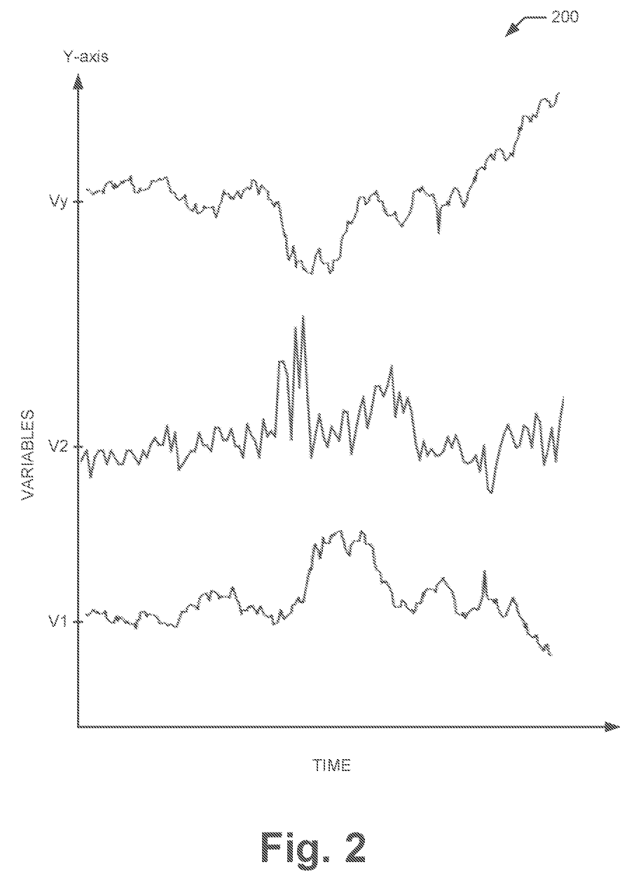

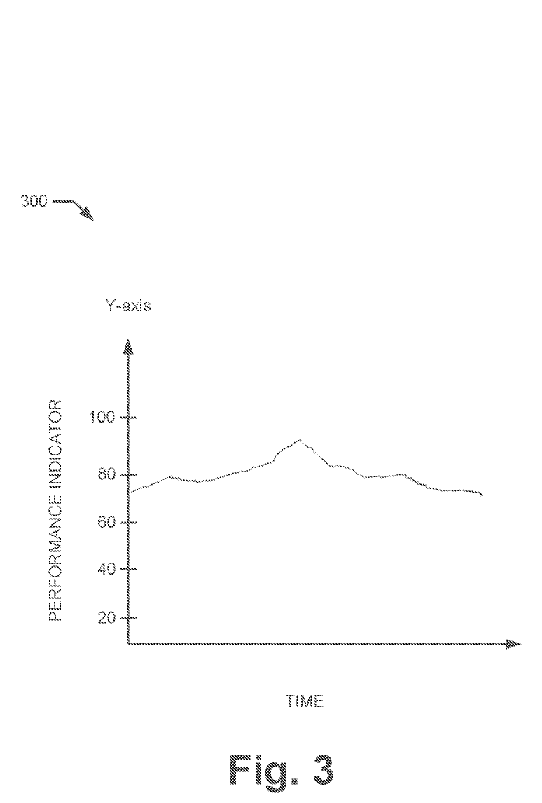

In one example, the datastore may also store historical time-series data related to the one or more operations linked with the industrial process environment. In one example, the historical time-series data may comprise a chronological sequence of observations or data points recorded at specific time intervals for each of the variables associated with each of the one or more operations. The data may span extended periods, such as months or years, providing a comprehensive record of past pattern, performance, and trends of the data points or values. For instance, if temperature is a monitored variable, the historical time-series data might include temperature readings taken at regular intervals (e.g., hourly, daily, or weekly) over the course of two years. Such a longitudinal dataset may allow for the identification of patterns, cycles, and long-term trends, along with time-varying dependence between each data point. The historical time-series data may thus be indicative of trend, behavior, or pattern of values for each of the variables. FIG. 2 illustrates an exemplary pattern 200 of values for different variables correlated with an operation linked with the industrial process environment, according to one example implementation of the present subject matter. The time-series data for each of the variables V1, V2,…, and Vy (where y is a natural number) may correspond to an operation, such as the operation 108, and may be recorded and stored in the datastore. The time-series data, corresponding to each of the variables, may indicate values (for example, on Y-axis) recorded at different intervals or over a period as indicated by the “TIME” axis. The time-series data may thus be indicative of the trend or pattern of values of each of the variables, V1 to Vy, correlated with the operation 108. Though illustrated together, the pattern of values of each variable may be indicated separately, in one example. In one example, the datastore may also store values of the performance indicator computed over a period of time.

In one example, the time-series data indicated by FIGS. 2 and 3 may be real-time data being recorded by devices, such as sensors, operationally linked with the operation 108 and/or being stored in the datastore. Such time-series data may indicate a pattern of values of each variable and the performance indicator correlated with the operation 108. In another example, the time-series data indicated by FIGS. 2 and 3 may be the historical time-series data collected over a period of time. Such historical time-series data may indicate past or historical patterns of values of each of the variables and the performance indicator correlated with the operation 108. In one example, previously or historically recorded variables and derived performance indicators may be referred to as historical variables and historical performance indicators, respectively. Thus, the historical time-series data may include or indicate the pattern of values of each of the variables and the performance indicator historically or previously recorded or derived.

Similarly, the datastore may include time-series data, or historical time-series data, for multiple operations, where, for each operation, the datastore may record the pattern of values of the variables and performance indicator linked with that operation. Further, though FIGS. 2 and 3 illustrate the time-series data, or historical time-series data, in the form of a graph, however, different ways or techniques of representation are also possible. For example, the time-series data, or historical time-series data, may be stored in the datastore in the form of an array of values for each of the variables, where each value may have associated therewith a timestamp. In yet another example, the time-series data, or historical time-series data, may be stored in the datastore in the form of an array of values collected at regular intervals. Similarly, other different ways to indicate and/or store the time-series data, or historical time-series data, may also be possible.

Further, the historical time-series data may be utilized to establish baseline performance, identify seasonal variations, detect anomalies, and inform predictive models. It may also serve as a valuable resource for comparative analysis, enabling operators to benchmark current operations against past performance. Additionally, the historical time-series data may be crucial for understanding the impact of past interventions, process changes, or external factors on the operations or the performance indicators, thereby facilitating more informed decision-making and process optimization strategies.

Further, the datastore may comprise, in one example, a set of storage devices capable of storing data, signals, and/or information. The set of storage devices may be virtual storage devices, physical storage devices, a cloud-based storage service, or a combination thereof. For example, the data source 106 may include any repository or storage unit implemented by physical, logical, and/or virtual storage devices. In one example, the data source 106 may include a set of physical storage devices. In another example, the data source 106 may include virtual storage devices being implemented on physical storage devices. In another example, the data source 106 may include one or more physical or logical storage units that may either be located at the same location or distributed geographically. In another example, the data source 106 may be implemented over a cloud-based storage service.

The computing environment 100 may also include, in one example, a computational model 110. The computational model 110 may be implemented as a set of algorithms, mathematical equations, or statistical methods designed to process input data and generate outputs or predictions. In another example, the computational model 110 may be implemented on a hardware device having stored thereon the set of algorithms, mathematical equations, or statistical methods. In some aspects, the computational model 110 may be based on machine learning techniques, such as neural networks, decision trees, or deep learning architectures. In one example, the computational model 110 may be trained on historical time-series data to learn patterns, relationships, or trends within the data, as will be discussed. In some cases, the computational model 110 may be continuously updated or refined as new data becomes available, allowing it to adapt to changing conditions or improve its accuracy over time.

The computational model 110 may be used for various purposes within the computing environment 100, such as data analysis, predictions, or other purposes. For example, the computational model 110 may process inputs from various sources, for example from the data source 106 and/or the system 102, and generate outputs or recommendations that can be used for informed decision-making processes. In one example, the computational model 110 may be used for lead time prediction and risk assessment, as will be discussed. In some implementations, the computational model 110 may be distributed across multiple computing nodes or devices within the computing environment 100, allowing for parallel processing and improved performance. The computational model 110 may also be designed to handle different types of data, including structured and unstructured data, time series, or multi-dimensional datasets. The computational model 110 may also incorporate techniques for handling uncertainty or incomplete data, such as probabilistic modeling or fuzzy logic. Further, in some aspects, the computational model 110 may be customizable or configurable, allowing it to be adapted for different use cases or domains within the computing environment 100. Such flexibility may enable the model to be applied to a wide range of applications, from industrial process optimization to financial forecasting.

In one example, the computing environment 100 may also include a workstation 112. In some examples, the workstation 112 may be a software-based application or tool. Examples of such tools and software may include, but are not limited to, data analysis tools, business software, websites or webpages, cloud-hosted platforms, analytical tools, and statistical tools. In some instances, the workstation 112 may be a hardware-based device. Examples of such workstation 112 may include, but are not limited to, a computing system or a desktop, a mobile, a laptop, Supervisory Control and Data Acquisition (SCADA) system. Such a workstation 112, in one example, may execute software-based application or tools that may be accessed by a user. The user may be, for example, an engineer, a statistical reconciliation expert, or any operator or worker associated with the industrial process environment.

Further, in one example, the workstation 112 may comprise a display device and an input mechanism. The input mechanism may be, for example, a keyboard, mouse, or even a touch input received on the display device of the workstation 112. In one example, the display device may be capable of rendering one or more graphical user interfaces. The workstation 112 may render one or more graphical user interfaces that may indicate different information about the industrial process environment, such as the probable lead time, pattern of values, and other data linked with the operations of the industrial process environment. The graphical user interface may be, for example, an interactive interface with which the user may be able to interact and view different information related to the industrial process environment and/or the components therein. For example, the user may be able to submit an assessment request and interact with data linked with the operations being rendered via the display device associated with the workstation 112. In one example, the graphical user interface may be a dashboard that may be rendered on the display device.

Further, the system 102, the data source 106, the computational model 110, and the workstation 112 may be communicably coupled with each other to exchange data and/or signals. In one example, the coupling may be direct, either wirelessly or through one or more wires. In another example, the system 102, the data source 106, the computational model 110, and the workstation 112 may be communicably coupled via a communication network 114 to exchange data and/or signals. The computing environment 100 may thus be a network of such entities that may be communicably coupled with each other, for example, over the communication network 114 to exchange data and/or signals. Examples of the communication network 114 may include, but are not limited to LAN, WAN, the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 114 may include various network entities, such as transceivers, gateways, and routers. In an example, the communication network 114 may include any communication network that uses any of the commonly used protocols, for example, Hypertext Transfer Protocol (HTTP), and Transmission Control Protocol/Internet Protocol (TCP/IP).

Thus, the computing environment 100 illustrates an example of an industrial process environment having different entities or components, and different combinations thereof, that may be communicably coupled with each other. Further, FIGS. 1A and 1B illustrate that the system 102 may be communicably coupled with the data source 106, the computational model 110, and the workstation 112. However, other implementations may also be possible. For example, the system 102 may comprise the processor 104, the data source 106, and the computational model 110, as illustrated in FIG. 1C. Similarly, different architectures may also be possible, though not illustrated.

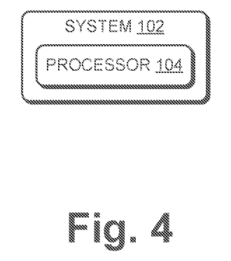

FIG. 4 illustrates a block diagram of the system 102, according to one example implementation of the present subject matter. FIG. 4 will be discussed in conjunction with FIGS. 1A to 3 for the sake of brevity and the description of FIGS. 1A to 3 shall be incorporated herein for reference.

In one example, the system 102 may be configured to assess various aspects of operations within the industrial process environment. For example, the system 102 may be configured to assess probable deviations by determining a probable lead time for the probable deviation. In one example, the system 102 may also be configured to assess the probable deviations by determining a probable risk associated with the probable deviation, as will be discussed.

In one example operation, the processor 104 may receive an assessment request for an operation, such as the operation 108, linked with an industrial process environment. In one example, the operation 108 may have linked therewith a plurality of variables, such as any of the variables V1 to Vy, and a performance indicator, such as the performance indicator 302, derived based on the plurality of variables. Further, the assessment request, in one example, may be for predicting a probable lead time to a probable deviation of the performance indicator 302 from a threshold value prescribed for the performance indicator.

In response to receiving the assessment request, the processor 104 may execute a computational model, such as the computational model 110, capable of predicting the probable lead time. The computational model 110 may be modelled with historical time-series data for predicting the probable lead time. In one example, the historical time-series data may indicate a pattern of values for each variable in a set of variables identified from amongst the plurality of variables. In one example, the computational model 110 may be modelled based on a relationship between a plurality of segments of the historical time-series data and a plurality of temporal buckets.

In one example, each segment may comprise a temporally synchronised series of the pattern of values of each variable in the set of variables. Further, one or more of the plurality of segments may comprise a series of the pattern of values of the set of variables causing a historical performance indicator to be at least proximate to a probable deviation from a historical threshold value. Further, each of the temporal buckets, in one example, may indicate a probable lead time to the probable deviation of the historical performance indicator. Each of the plurality of segments may be linked with a temporal bucket, from amongst the plurality of temporal buckets, based on a degree of proximity of the historical performance indicator with the historical threshold value. For example, each segment may be linked to a temporal bucket based on how close the segment’s patterns are to causing deviation of the historical performance indicator. Further, as each of the segments may be indicative of a pattern or behavior of the pattern of values, modelling or training based on relationships between the segments and the temporal buckets may enable the computational model to determine temporal buckets based on behavior of the pattern of values of the variables.

In response to being executed, the computational model 110 may identify a segment, from amongst the plurality of segments, based on behavior of each variable in the set of variables. In one example, the behavior may be indicated by a trend of values of each variable in the set of variables recorded immediately prior to reception of the assessment request. For instance, the computational model 110 may identify a segment that may map with the trend of values of the set of variables that may have been recently recorded or observed. In another example, the computational model 110 may analyze the values of each variable in the set of variables at time “t”. The time “t” may be a current time synchronized with a general clock or a time of reception of the assessment request. The values at time “t”, because of their time-series nature, may have dependency on values recorded at least immediately prior to time “t”. Thus, the values recorded prior to time “t” may have an impact on the values at time “t” due to the sequential nature of timeseries. The computational model 110 may then identify a segment that may correspond or match with the behavior indicated by the values of each variable in the set of variables at the time “t”. Thus, the computational model 110 may identify a segment, which indicates pattern or behavior of values, that probably matches with the behvaior indicated by the values of the variables at time “t”. The computational model 110 may then determine a temporal bucket, from amongst the plurality of temporal buckets, linked to the identified segment.

Further, in response to the determination of the temporal bucket, the processor 104 may generate a lead time indication signal to cause rendering of the determined temporal bucket. The temporal bucket may indicate the probable lead time to the probable deviation of the performance indicator from the threshold value prescribed for the performance indicator. in one example, the probable lead time may be a range of duration, such as 3 to 4 hours.

The disclosed subject matter may enable comprehensive and proactive management of operations by providing early, temporally specific warnings about potential deviations. For instance, by utilizing historical time-series data and the computational model 110, the lead time or duration to occurrence of the probable deviation may be predicted. This temporal information enables operators to prioritize their responses based on urgency and allocate resources more effectively. This may also allow operators to take preventive action before critical issues arise, potentially reducing downtime and improving operational efficiency. Further, the computational model's ability to derive temporal buckets from various patterns of historical data allows it to adapt to different types of performance metrics and industrial processes without extensive reconfiguration.

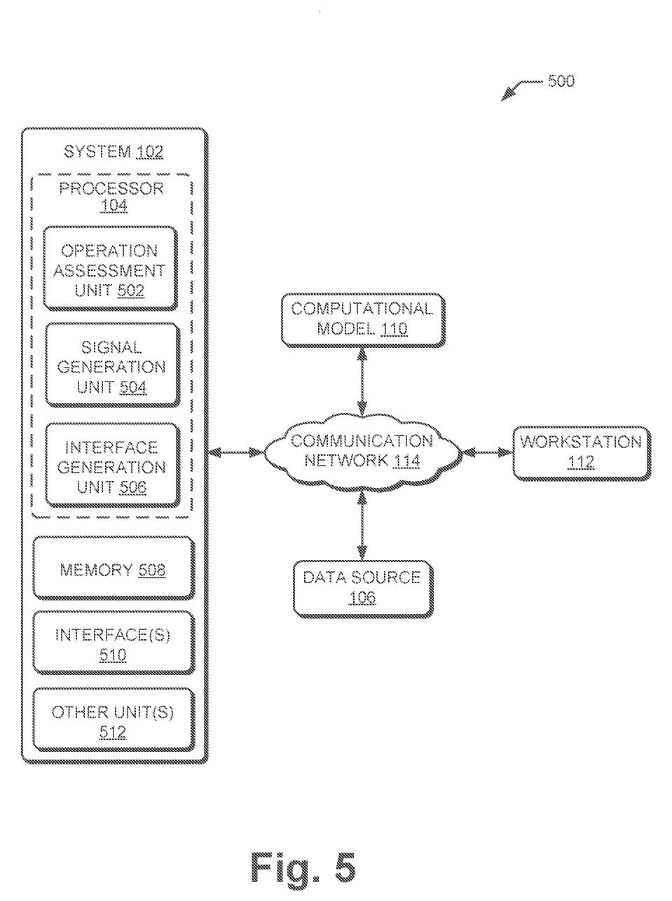

FIG. 5 illustrates a block diagram of a computing environment 500 comprising the system 102, according to another example implementation of the present subject matter. FIG. 5 will be discussed in conjunction with FIGS. 1A to 3 for the sake of brevity. The subject matter disclosed in the description of FIGS. 1A to 3 will be incorporated herein as reference for the sake of brevity.

In one example, the computing environment 500 may be similar to the computing environment 100 discussed with reference to FIGS. 1A to 1C. The computing environment 500, similar to the computing environment 100, may include the system 102, the data source 106, and the computational model 110. In one example, the computing environment 500 may also include the workstation 112. The system 102, the data source 106, the computational model 110, and the workstation 112 may be communicably coupled with each other over the communication network 114 to exchange data and/or signals.

As discussed above, the computing environment 500 may include the system 102 configured to assess various aspects of operations within the industrial process environment. For example, the system 102 may be capable of assessing or evaluating potential deviations of one or more operations by determining a probable lead time to such deviations, allowing for proactive assessment and management of operational performance. The system 102 may utilize various data inputs, analytical models, and algorithms to perform these assessments or evaluations. For example, the system 102 may consider the historical time-series data, real-time data related to the operations to identify trends and patterns that could indicate potential deviations. The system 102 may also be capable of evaluating potential risks associated with such deviations. For example, the system 102 may be configured to indicate a risk indicator or score quantitatively indicating a measure of risk associated with the deviation. By assessing both the timing of these deviations and risk associated therewith, the system 102 may provide valuable insights for operational planning, maintenance scheduling, and process optimization.

In one example, the system 102 may also be capable of data visualization capabilities to effectively and dynamically indicate the results of such assessments. For example, the system 102 may be configured to cause rendering of one or more graphical user interfaces to indicate the probable lead time and the risk associated with the probable deviation. Further, the system 102 may have the ability to integrate with existing industrial control systems, enabling seamless deviation assessment in the industrial process environment.

In one example, the system 102 may include the processor 104. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, neural network-based processors, machine learning-based processors, deep learning-based processors, system on chip (SOC), processing circuitries including one or more modules or engines, and/or any other devices that manipulate signals and data based on computer-readable instructions, and/or any other devices.

In one example, the processor 104 may include one or more sub-processing units or engines. For example, the processor 104 may include an operation assessment unit 502, a signal generation unit 504, and an interface generation unit 506. The units may be implemented as a combination of hardware and programming, for example, programmable instructions to implement a variety of functionalities of the units. In examples described herein, such combinations of hardware and programming may be implemented in several different ways. For example, the programming for the units or engines may be executable instructions. Such instructions in turn may be stored on a non-transitory machine-readable storage medium which may be coupled with the system 102 either directly or indirectly (for example, through networked means). In an example, it may also be possible that each of the units or engines includes a processing resource, for example, a single processor or a combination of multiple processors, to execute such instructions. In one example, such instructions may be stored in a memory 508 of the system 102. The memory 508 may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes. In one example, the memory 508 may store the data received, processed, or generated by the system 102 and/or the processor 104. In other examples, the units or engines may be implemented as electronic circuitry.

The system 102 may further comprise, in one example, interface(s) 510. The interface(s) 510 may include a variety of software and hardware interfaces that allow interaction of the system 102 with other communication and computing devices, such as network entities, web servers, external repositories, control systems, and peripheral devices, such as input/output (I/O) devices. For example, the interface(s) 510 may communicably couple the system 102 with the data source 106, the computational model 110, the workstation 112, and the communication network 114, and any other existing solution or control system associated with the industrial process environment. The interface(s) 510 may also enable the coupling of internal components of the system 102 with each other.

The system 102 may further comprise, in one example, the other unit(s) 512. The other unit(s) 512 may include, in one example, a power supply unit and a communication unit. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to be communicably coupled with the data source 106, the computational model 110, the workstation 112, and the communication network 114. Also, the communication unit may allow the system 102 to transmit and receive data, files, and/or signals.

In one example operation, the processor 104, or the operation assessment unit 502, may receive an assessment request for an operation, such as the operation 108 linked with the industrial process environment. The processor 104 may receive the assessment request, in one example, from a user. The user may be, for example, one or more operators or engineers associated with the industrial process environment and/or the operation 108. The user, in one example, can also be an individual user requiring assessment of the operation 108 linked with the industrial process environment. In one example, the user may raise such a request via the workstation 112. For example, the display device of the workstation 112 may render a user interface enabling the user to initiate the assessment request for the operation 108. In another example, the user may initiate the assessment request via a device associated with the user. Examples of such a device may include, but are not limited to, a mobile phone, a laptop, a tablet, and a computer system. In yet another example, the assessment request may be initiated via one or more websites, web pages, software application, or other platforms linked with the industrial process environment. In one example, the processor 104 may receive the assessment request for the operation 108 via the communication network 114.

In one example, it may also be possible that the assessment request may be generated by the processor 104 itself. For example, after a predefined time interval or at regular time intervals, the processor 104 may generate the assessment request for assessing the operation 108. As such generation may trigger the assessment of the operation 108, the generation may also be referred to as receiving of the assessment request. The regular time interval or the predefined time interval may be defined by, for example, the user via the workstation 112. Such mechanized assessment requests may enable the processor 104 to assess the operation 108 from time to time, without necessitating manual triggering of such requests.

Further, in one example, the operation 108 may be an industrial operation or process being implemented or executed in the industrial process environment. In another example, the operation 108 may be a group of interlinked operations associated with the industrial process environment. The operation 108 may have linked therewith a plurality of variables and a performance indicator derived based on the plurality of variables. The plurality of variables may be linked with, in one example, input and/or output characteristics of the operation 108. Examples of input and/or output characteristics may include, but are not limited to, temperature, pressure, flow rate, quantity, quality, volume, size of data, network speed, and bitrate. For example, a variable may indicate a volume of crude oil provided as an input for the operation 108 for further processing, the volume being the input characteristic. Also, for example, another variable may indicate an amount of processed oil generated by that operation 108, the amount being the output characteristics of the operation 108. In addition to the previously mentioned input and output characteristics, variables may also indicate equipment-specific metrics such as rotational speed of turbines, vibration levels of machinery, or electrical current draw of motors. Environmental parameters like ambient temperature, humidity, or air quality may also be monitored as they can impact process efficiency. In some cases, the variables may indicate raw material properties, such as viscosity, density, or chemical composition, that may be crucial for certain operations.

Further, the performance indicator may be derived based on the plurality of variables, as discussed above. For example, the set of parameters may be processed through one or more mathematical functions, statistical operations, or other computational operations to obtain the performance indicator. In one example, the performance indicator may be a KPI. The performance indicator may quantitatively indicate, for example, an aspect about the operation 108 and the plurality of variables correlated with the operation 108. Examples of such aspects may include, but are not limited to, overall equipment effectiveness, energy efficiency, product quality, defect rates, consistency of output, composite scores, time-based derivatives, aggregated data that summarizes the set of parameters, and compliance with industry standards. The performance indicator may be derived based on complex functions or simple calculations that combine multiple parameters to produce a meaningful metric. In one example, the performance indicators, for the operation 108, may have already been derived based on the variables linked with the operation 108 and may be stored in the datastore of the data source 106. Similarly, values of each variable, in the plurality of variables, may also be stored in the datastore, as discussed above, as the operation 108 may be implemented in the industrial process environment. In one example, values of the performance indicator and each of the variables may be stored as time-series data, as discussed above and in FIGS. 2 and 3.

Further, the assessment request, in one example, may be for predicting a probable lead time to a probable deviation of the performance indicator from a threshold value prescribed for the performance indicator. For example, the assessment request may be to determine or predict a duration, from the time of the assessment request, after which the performance indicator is likely to deviate from the prescribed threshold value. In other words, the assessment request may be to predict a duration after which the performance indicator, linked with the operation 108, may probably deviate in future.

The threshold value, in one example, may be a range of values prescribed for the performance indicator. For example, the range may comprise an upper bound value and a lower bound value. The upper bound value and the lower bound value may define an acceptable range of value for the performance indicator. Non-compliance of the performance indicator with at least one of the upper bound value and the lower bound value may be ascertained as the probable deviation. In another example, the threshold value may be a single finite value defining a threshold limit for the performance indicator. In one example, the threshold value may be defined by the user, and may also be modifiable. For example, the user may define the threshold value for the performance indicator linked with the operation 108 via the workstation 112 or any other capable interface. In another example, the threshold value may be a predefined value for the operation 108.

Further, in response to receiving the assessment request, the processor 104, or the operation assessment unit 502 of the processor 104, may execute the computational model 110. In one example, the computational model 110 may be communicatively coupled with the processor 104, as illustrated in FIG. 5. In another example, it may also be possible that the computational model 110 may be a part of the system 102 itself, as illustrated in FIG. 1C, and communicably coupled with the processor 104. In yet another example, though not illustrated, the computational model 110 may be deployed on the processor 104 or may be a sub-processing unit or engine like the operation assessment unit 502, the signal generation unit 504, and the interface generation unit 506.

In one example, the computational model 110 may be capable of predicting the probable lead time. The computational model 110 may be modelled or trained with the historical time-series data for predicting the probable lead time. As discussed above and with reference to FIGS. 2 and 3, the historical time-series data may include pattern of values of the variables and the performance indicator recorded or derived in the past for the operation 108, an upcoming deviation of which is now to be assessed.

In one example, the historical time-series data of all the variables linked with the operation 108 may not be used for modelling the computational model 110. For example, historical time-series data of a set of variables identified from amongst the plurality of variables may only be used for modelling the computational model 110. That is, the computational model 110 may be modelled or trained with the historical time-series data indicating a pattern of values for each variable in a set of variables identified from amongst the plurality of variables.

In one example, the processor 104 may identify the set of variables from amongst the plurality of variables by determining a potential causal effect of each variable, from amongst the plurality of variables (such as V1 to Vy), on the performance indicator. In one example, such identification may be done once to determine the set of variables for modelling the computational model 110 and may not be performed everytime an assessment request is received.

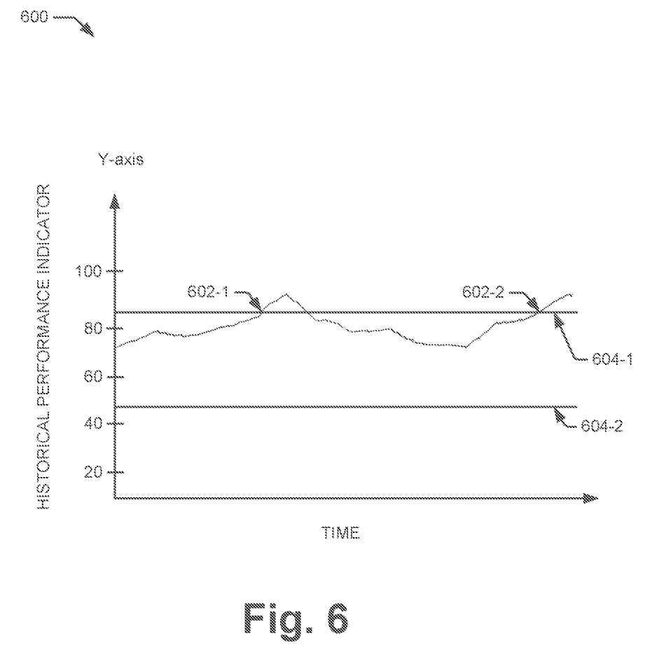

In one example, to identify the set of variables, the processor 104 may process or analyse historical time-series data indicating the behavior or pattern of values of the performance indicator recorded in the past, or at least prior to reception of the assessment request, for the operation 108. In one example, the analysis may be to identify variables, from amongst the plurality of variables V1 to Vy that may actually have a causal effect on the performance indicator, and may thus have caused the performance indicator to deviate from a historically defined threshold value, hereinafter referred to as historical threshold value. FIG. 6 illustrates a historical time-series data 600 indicating the pattern of values of the performance indicator, according to one example implementation of the present subject matter. As illustrated in FIG. 6, the historical time-series data 600 may indicate past deviations 602-1 and 602-2 of the historical performance indicator, recorded or observed previously or historically and linked with the operation 108, from the historical threshold value. Similarly, there may be N number of deviations, though not illustrated, where N is a natural number. The deviations 602-1 to N may collectively be referred to as deviations 602 and individually be referred to as deviation 602. Further, in one example, the historical threshold value may be a single finite value. In another example, the historical threshold value may be a range of values having an upper limit, as indicated by 604-1, and a lower limit, as indicated by 604-2. The historical threshold value may hereinafter be referred to as the historical threshold value 604.

In one example, as the historical performance indicator linked with the operation 108 may have been derived based on historically recorded values of the underlying variables, such as the variables V1 to Vy, indicated by the historical time-series data of the variables linked with the operation 108, the processor 104 may perform a causal analysis to identify the set of variables, from amongst the plurality of variables, that may have potentially caused the deviations 602 in the past. In one example, the processor 104 may compute how much each variable influences the historical performance indicator. The variables that have a stronger effect on the historical performance indicator may be identified for the set of variables. To determine this influence or causal effect, the processor 104 may use various techniques.

For example, the processor 104 may slightly change one variable while keeping others constant, and observe how much this affects the historical performance indicator. The variables may be systematically varied while other variables are held constant, allowing for the observation of direct effects on the historical performance indicator. The variables that cause larger changes or deviations when adjusted may be identified as having a strong causal effect. In one example, processor 104 may compute a potential contribution score for each variable linked with the operation 108. The potential contribution score may quantitatively indicate an extent of influence or causal effect of each of the variables on the performance indicator. The potential contribution score may also be indicative of contribution of each of the variables in causing deviation of the historical performance indicator. The variables that cause larger changes in the historical performance indicator may be assigned a higher potential contribution score as compared to the variables causing comparatively lesser change. The processor 104 may also look for patterns in how parameters interact. Some variables might have a stronger effect when combined with others. The processor 104 may identify these complex relationships, revealing correlations that might not be obvious through simpler analysis.

Thus, for each variable, the processor 104 may determine a score or value, referred to as the potential contribution score, indicating its causal effect on the historical performance indicator. The potential contribution score could be a number showing how much the historical performance indicator is expected to change when the variable changes. Therefore, the processor 104 may then identify one or more variables for the set of variables by evaluating a causal relationship between each of the variables and the historical performance indicator. In one example, the processor 104 may compare potential contribution score computed for each of the variables with a causal threshold score. In one example, the causal threshold score may be defined by the user via the workstation 112. The variables having the potential contribution score greater than the threshold potential contribution score may be identified as having a strong causal effect on the historical performance indicator, and may be added to the set of variables. The set of variables may thus be identified as having a considerable effect and probable reasons for deviations of the historical performance indicator in the past.

Further, though it has been discussed that the processor 104 may identify the set of variables, in another example, the computational model 110 may also be configured and/or capable of performing causal analysis similarly for determining the set of variables. Other techniques could also be employed to determine the causal relationship. For example, time series analysis may be employed to examine how changes in variables over time relate to subsequent changes in the historical performance indicator. In some instances, SHAP analysis or Machine learning techniques may be utilized for causal analysis. For example, causal inference algorithms such as causal forests or causal trees may be employed to estimate the causal effects of variables on the historical performance indicator. In some cases, structural equation modeling (SEM) may be used to analyze complex causal relationships. SEM may allow for the simultaneous examination of multiple causal pathways and can account for both direct and indirect effects of variables on the historical performance indicator. This approach may be valuable for dealing with complex systems where multiple factors interact to influence outcomes. In practice, a combination of these methods could also be used to perform comprehensive causal analysis.

As discussed above, and reiterated here for reference, the historical time-series data may include or indicate the behavior or pattern of values of the performance indicator historically recorded or derived. The performance indicator, when referring to its past values or patterns, may be termed the historical performance indicator. In essence, the historical performance indicator is not a separate entity, but rather the same performance indicator viewed through the lens of its past behavior or data. Thus, the historical performance indicator and the performance indicator are not separate entities, but rather different temporal perspectives of the same metric. For example, the performance indicator may represent the present or upcoming state or value of the metric. When this same indicator is examined through the lens of its past behavior or data, it may be referred to as the historical performance indicator. Thus, the collection of all past values of the same indicator forms what may be referred to as the historical performance indicator. Similarly, the historical threshold value and the threshold value may not be separate, in one example, but rather different temporal perspectives of the same metric. The historical threshold value may indicate a value or range of values defined as threshold in the past, whereas the threshold value may be a currently applicable threshold for the performance indicator. In one example, the threshold value may be defined by the user via the workstation 112 for the performance indicator linked with the operation 108.

The historical time-series data may reveal behavior, patterns, trends, or fluctuations over time, which can be analyzed to gain insights into the behavior of the indicator. Thus, the computational model 110 may be trained with the historical time-series data for being capable of predicting the probable lead time. In one example, the historical time-series data of only the set of variables may be used for modelling the computational model 110. As discussed above, the set of variables may include one or more variables identified from amongst the plurality of variables, for example, based on their causal effect on the historical performance indicator. The historical time-series data may indicate a pattern of values for each variable in the set of variables identified from amongst the plurality of variables. Thus, the computational model 110 may be trained with at least the variables that actually impacted the historical performance indicator in the past, instead of a large but undirected data of all the variables. By training the computational model 110 with variables that have demonstrably impacted the historical performance indicator, rather than using a large but undirected dataset of all variables, improved predictive accuracy and computational efficiency may be achieved. This approach may also reduce noise in the training data, potentially leading to faster convergence during training and more robust predictions.

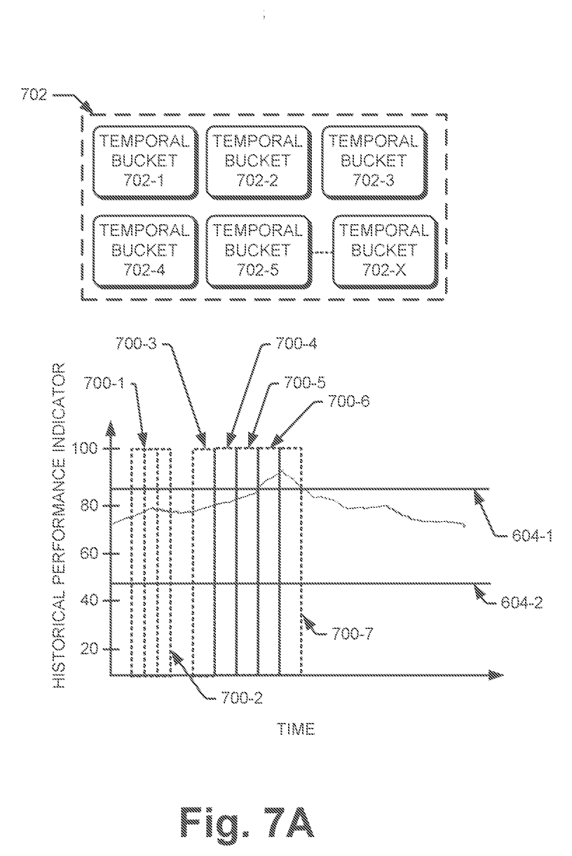

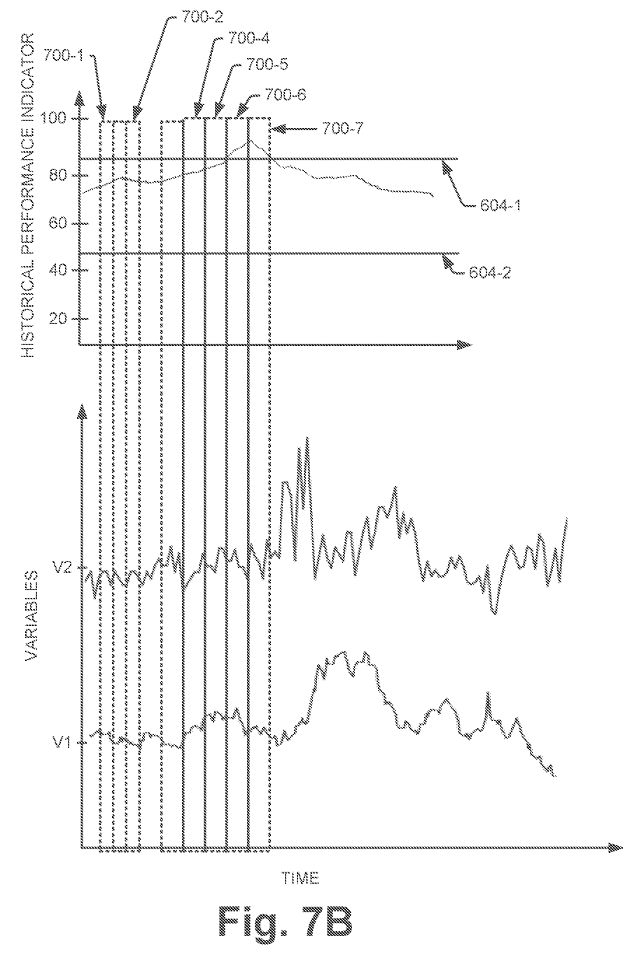

In one example, the computational model 110 may be trained based on a relationship between a plurality of segments of the historical time-series data and a plurality of temporal buckets. FIGS. 7A to 7B illustrate the relationship between the plurality of segments and the plurality of temporal buckets, according to one example implementation of the present subject matter.

In one example, the plurality of segments, such as the segments 700-1 to 700-X (where X is a natural number), may be identified on the historical time-series data of the historical performance indicator, as illustrated in FIG. 7A. The plurality of segments may collectively be referred to as segments 700. Each of the segments 700 may be a patch having a predefined patch length. In one example, the patch length may be a temporal length or duration, such as 2 seconds, 5 seconds, 10 seconds, or any other suitable duration, indicating a series or portion of the trend or pattern of values of the historical performance indicator within that temporal length. The patch length, in one example, may be defined by the user through a user interface or the workstation 112, or may be automatically determined based on the characteristics of the historical time-series data such that a predefined number of patches may be identified or patches having equal patch length may be identified.

In one example, the segments 700 may be sliding windows being slid over the historical time-series data of the historical performance indicator. The sliding may occur at regular intervals, such as every second, every 5 seconds, or at any other suitable interval. Thus, each of the segments 700 may capture a series or portion of the pattern of values of the historical performance indicator. The captured portion may include various data points, such as minimum and maximum values, average values, or specific events within the temporal length, indicating behavior of the data points within that patch or segment. The model may use the sliding window approach to analyze the behavior of values of the variables, which may help in capturing both short-term fluctuations and long-term trends in the data.

Further, the segments 700, in one example, may temporally overlap, at least partially, with an adjacent segment. For example, the segment 700-1 may temporally and partially overlap with the adjacent segment 700-2, the segment 700-2 may partially overlap with its adjacent segment, and so on till the segment 700-X which may be the last segment indicating the end of the pattern of values of the historical performance indicator. Such temporal overlapping may define temporal linkage or connection between values of the historical performance indicator. This overlapping approach may help in capturing continuous behavior or patterns that might span across multiple segments, ensuring that important features or transitions in the data are not missed due to arbitrary segmentation. The overlapping may also assist in smoothing out any abrupt changes or anomalies that might occur at the boundaries of non-overlapping segments.

In some cases, the segmentation process may involve preprocessing steps such as data normalization or filtering to enhance the quality of the segments. Additionally, the segmentation may be adaptive, adjusting the patch length or overlap based on the complexity or variability of the data in different regions of the time series.

Further, as the values of the historical performance indicator may have been derived based on the underlying variables, each segment may be linked to corresponding portions of the pattern of values for each of the underlying variables. For example, each of the segments 700 may be associated with a corresponding series or portions of the pattern of values of each variable in the set of variables that were identified based on their causal effect, as discussed above. If the set of variables includes the variables V1 and V2, each segment 700-1 to 700-X may be linked to the specific portions of the value patterns of V1 and V2 (as illustrated in FIG. 7B) that occurred during the timeframe of that segment and contributed to the pattern of values of the historical performance indicator within that same segment. For example, segment 700-1 may be linked to the portions of V1 and V2 patterns that occurred during its timeframe and influenced the historical performance indicator's values in that segment 700-1. Segment 700-2 would be linked to the subsequent portions of V1 and V2 patterns, corresponding to its specific timeframe. This pattern continues for all segments up to 700-X. Thus, each segment indicates a series of the pattern of values of each variable in the set of variables.

Such linkage allows for a direct correlation between each segment of the historical performance indicator and the concurrent portions of the underlying variable’s patterns, facilitating analysis of how changes in the underlying variables relate to changes in the historical performance indicator across different segments. Such correlation may also facilitate detection of patterns or trends in the relationships between variables and the historical performance indicator over time. By maintaining these linkages, a granular understanding of the dynamic relationships between the underlying variables and the historical performance indicator throughout the entire time series may be achieved, enhancing the ability to analyze, predict, and optimize performance based on the behavior of contributing variables.

Further, one or more of the plurality of segments 700 may indicate a series of the pattern of values of the set of identified variables causing the historical performance indicator to be at least proximate to a probable deviation from the historical threshold value. For example, as the historical performance indicator may have deviated from the historical threshold value in the past, some of the segments, such as the segments 700-5 and 700-6, may indicate such pattern of values of the historical performance indicator, as illustrated in FIG. 7A. These segments may also correspond to a series of patterns of values of the identified set of variables, illustrated in FIG. 7B, which may be associated with the historical performance indicator being at least proximate to a probable deviation from the historical threshold value. Thus, the segments, such as the segments 700-5 and 700-6, may be indicative of a behavior or series of pattern of values of the identified set of variables, as illustrated in FIG. 7B, that may have caused the historical performance indicator to be at least proximate to a probable deviation from the historical threshold value. That is, some of the segments, such as the segment 700-5 may indicate the behavior or pattern of the values, of each variable in the set of variables, that probably led the historical performance indicator to be proximate or approaching the historical threshold value, whereas the segment 700-6 may indicate the behavior or pattern of values that led the historical performance indicator to probably deviate from the historical threshold value.

Further, each of the plurality of temporal buckets may indicate a probable lead time to the probable deviation of the historical performance indicator. For example, the plurality of temporal buckets may comprise temporal buckets 702-1 to 702-X (where X is a natural number). The temporal buckets 702-1 to 702-X may be collectively referred to as temporal buckets 702 and individually referred to as temporal bucket 702. Each temporal bucket 702 may indicate a unique probable lead time. The probable lead time may indicate a range of duration to the probable deviation of the historical performance indicator from the historical threshold value prescribed for the historical performance indicator. For example, the temporal bucket 702-1 may indicate 4 to 5 hours as the probable lead time to the probable deviation of the historical performance indicator, the temporal bucket 702-2 may indicate 3 to 4 hours, and so on, with the temporal bucket 702-X indicating 0 to 1 hour.

In one example, each temporal bucket 702 may have an equal time window or temporal width. For instance, each temporal bucket may span a 1-hour time window. The number of temporal buckets 702 may be determined based on the desired temporal width to be maintained for each temporal bucket 702. In some cases, the temporal width may be defined by the user via the workstation 112. Alternatively, the temporal width may be defined based on the processing power or capabilities of the computational model 110.

Further, in one example, temporal buckets may be arranged in a sequential order, with each bucket representing a specific time range leading up to the probable deviation. For example, in a system with 5 temporal buckets, each spanning 1 hour. Temporal bucket 702-1 may represent 4-5 hours before the probable deviation, temporal bucket 702-2 may represent 3-4 hours before the probable deviation, …., temporal bucket 702-4 may represent 1-2 hours before the probable deviation, and the temporal bucket 702-5 may represent 0-1 hours before the probable deviation. Such an arrangement allows for a granular analysis of the lead time to the probable deviation, enabling more precise predictions and interventions. The number of temporal buckets and their respective time ranges may be adjusted based on the specific requirements of the system, the nature of the historical performance indicator being monitored, and the desired level of predictive accuracy.

Further, the computational model 110 may be modelled based on the relationship between the plurality of segments 700 and the plurality of temporal buckets 702. In one example, the computational model 110 may be supervisingly modelled by indicating inputs (segments 700) that are mapped to outputs (temporal buckets 702). That is, the computational model 110 may be modelled using supervised learning techniques where the computational model 110 may be trained by indicating suitable output for a corresponding input. Thus, the computational model 110 may be modelled by indicating a relationship between the plurality of segments 700 and the plurality of temporal buckets 702.

In one example, each of the plurality of segments 700 may be linked with a temporal bucket based on a degree of proximity of the historical performance indicator with the historical threshold value. For example, a segment, from amongst the plurality of segments 700, comprising a series of pattern of values (of each variable in the set of variables) causing the historical performance indicator to be proximate to the probable deviation may be linked with a temporal bucket, from amongst the plurality of temporal buckets 702, indicating increased temporal proximity to the probable deviation, as compared to another segment comprising a series of pattern of values (of the set of variables) causing the historical performance indicator to be comparatively distanced from the probable deviation. That is, the segments containing patterns of values that indicate the historical performance indicator is approaching a deviation are mapped to temporal buckets representing shorter lead times; and segments with patterns showing the historical performance indicator far from deviation are mapped to buckets with longer lead times (such segments may also be referred to as normal segments).

In one example, the mapping may be performed by linking the segment indicating the probable deviation of the historical performance indicator with the temporal bucket indicating the least lead time to deviation or most temporal proximity to the deviation. For example, the segment 700-5 (indicating the historical performance indicator to be deviating from the historical threshold value) may be linked with the temporal bucket 702-5 representing 0-1 hours to the probable deviation. Similarly, the segment 700-4 (indicating the historical performance indicator to be deviating from the historical threshold value, but having a lower degree of proximity with the historical threshold value) may be linked with the temporal bucket 702-4 representing 1-2 hours before the probable deviation. Similarly, each of the plurality of segments 700 may be mapped or linked with the temporal buckets 702.

In another example, the mapping may be performed by identifying a segment indicating the probable deviation of the historical performance indicator from the historical threshold value. Once such a segment, such as the segment 700-5 is identified, a probable lead time or duration may be determined. In one example, the probable lead time or temporal width may be determined based on the processing power or prediction capabilities of the computational model 110. For example, consider the lead time to be determined as 5 hours, based on the prediction power or capability of the computational model 110. If a 5-hour lead time is determined, a temporal window of 5 hours is defined, extending from the point of probable deviation back to 5 hours prior to this point in the historical time-series data. The temporal window of 5 hours may then be divided into temporal buckets of equal temporal width, as discussed above with respect to temporal buckets 702-1 to 702-5, each bucked being of 1 hour temporal width. Similarly, segment width may be defined to ensure each segment 700 captures time-series data of equal temporal width, and temporal synchronization between temporal buckets and segments may be achieved. For example, segments 700-1 to 700-5 may be defined, each indicating 1 hour of the time-series data, where the segment 700-5 indicates the series of pattern of values of the historical performance indicator deviating from the historical threshold value.

Each of the segments 700-1 to 700-5 may then be linked or mapped to a temporal temporal bucket from the temporal buckets 702-1 to 702-5, based on their degree of proximity with the historical performance indicator indicated by the segment. For example, the segment 700-5 may be linked with temporal bucket 702-5 (indicating the probable lead time of 0 to 1 hours), the segment 700-4 may be linked with the temporal bucket 702-4 (indicating the probable lead time of 1 to 2 hours), and so on. In one example, the number of temporal buckets and the temporal width may be defined by the user via the workstation 112.

In one example, some of the segments may be mapped or linked with null temporal buckets that may not indicate any lead time. For example, consider some of the segments, say the segments 700-1 and 700-2, may indicate a series of pattern of values of the historical performance indicator that are distanced from the historical threshold value, indicating that the probable deviation may not be close. Such segments may also be referred to as normal segments and may not be linked with any of the temporal buckets 702 as the probable deviation may not be considerably close or as there may be chances that the deviation may not even occur. Excluding the normal segments that are distanced from the historical threshold value helps filter out data that may not contribute significantly to deviation predictions. Also, by omitting mappings for less relevant segments, the resulting data structure becomes more streamlined and easier to interpret. Thus, only meaningful or useful segments may be mapped with the temporal buckets, thereby reducing data processing for creating unnecessary mappings. By prioritizing segments that indicate deviations, computational resources can be allocated more effectively.

Therefore, the computational model 110 may be configured by defining relationships between the plurality of segments 700 and the plurality of temporal buckets 702 for predicting the probable lead time. In one example, the configuration or modelling may enable the computational model 110 to predict the probable lead time to deviation of the performance indicator from the threshold value in real-time scenarios, upon receiving the assessment request.

In one example, in response to being executed upon receiving the assessment request, the computational model 110 may identify a segment, from amongst the plurality of segments 700, that probably corresponds to a trend of values of the set of variables. As previously discussed, the operation 108 may have linked therewith the plurality of variables, from which the set of variables may be identified based on their causal effect of the historical performance indicator. As also discussed, the time-series data, indicating the behavior or pattern of values of the variables (and thereby the set of variables) may be stored and/or generated by the data source 106.

Thus, in response to receiving the assessment request and upon being executed, the computational model 110 may analyze the trend or pattern of values of the set of variables recorded immediately prior to reception of the assessment request. In one example, as the operation 108 may be implemented in the industrial process environment, the data source 106 may generate and/or store values of the set of variables linked with the operation 108. Based on the trend of values of the set of variables, such as the variables V1 and V2 discussed above, the computational model 110 may identify a segment, from amongst the plurality of segments 700, that may correspond to the trend of values of the set of variables. For example, each of the segments 700 may indicate a series of pattern of values of the set of variables, as discussed above and with reference to FIG. 7B. The computational model 110 may analyze the trend of values and identify a segment, from amongst the segments 700, that may probably be matching with the trend of values. For example, the computation model 110 may partition the trend of values into a plurality of sections, like the segments 700. The computational model 110 may then compare each of the sections with the segments 700, to identify a matching segment.

In another example, the computational model 110 may identify a segment, from amongst the plurality of segments, based on behavior of each variable in the set of variables. In one example, the behavior may be indicated by the trend of values (or time-series data) of each variable in the set of variables recorded immediately prior to reception of the assessment request. The computational model 110 may analyze the values of each variable in the set of variables at time “t” and extract relevant features about the behavior of each variable in the set of variables at the time “t”. The time “t” may be a current time synchronized with a general clock or a time of reception of the assessment request. The values at time “t”, because of their time-series nature, may have dependency on values recorded at least immediately prior to time “t”. Thus, the values recorded prior to time “t” may have an impact on the values at time “t” due to the sequential nature of the timeseries. The computational model 110 may then identify a segment that may correspond or match with the behavior indicated by the values of each variable in the set of variables at the time “t”. For example, the computational model 110 may utilize similarity measures specifically designed for time-series data to compare the behavior of variables at the time “t” with behaviors captured in the predefined segments or patterns of the historical time-series data. Thus, the computational model 110 may identify a segment, which indicates pattern or behavior of values, that probably matches with the behvaior indicated by the values of the variables at time “t”.

Once a corresponding segment is identified, the computational model 110 may then determine a temporal bucket, from amongst the plurality of temporal buckets 702, linked with the identified segment. For example, the computational model 110 may identify the segment 700-4 as the corresponding segment, based on the trend of values. Considering, for example, the temporal bucket 702-4 may be linked or mapped with the segment 700-4. The computational model 110 may thus determine the temporal bucket 702-4, indicating 1 to 2 hours, from the temporal buckets 702.

Thus, when an assessment request for the operation 108 is received, say at the time “t”, by the processor 104 for assessing deviation of the operation 108, the probable lead time to probable deviation may be determined based on the behavior indicataed by the trend of values of each variable in the set of variables, recorded prior to reception of the request. That is, based on the currently existing trend of values of the set of variables, the probable lead time indicating a duration to the probable deviation of the performance indicator linked with the operation 108 may be determined. The probable lead time may thus indicate the duration remaining to the upcoming probable deviation of the performance indicator linked with the operation 108. Considering the above example of the determination of the temporal bucket 702-4, the probable lead time may be 1 to 2 hours.

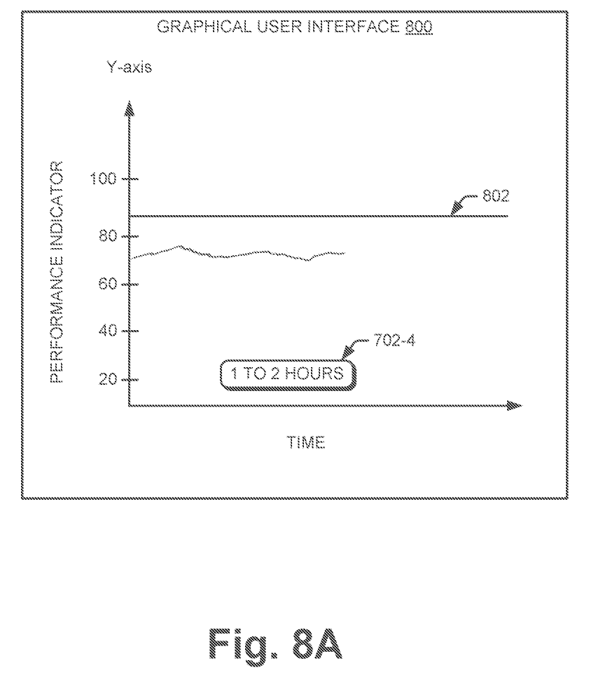

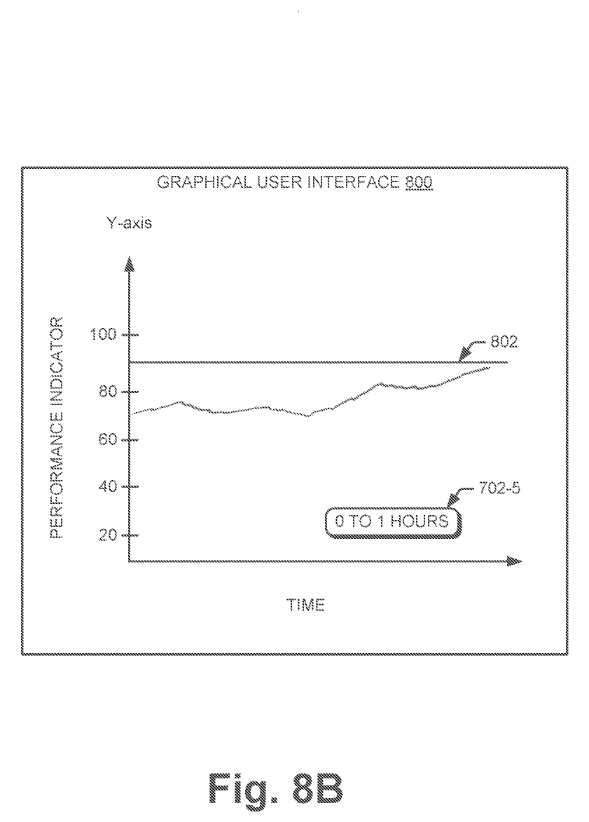

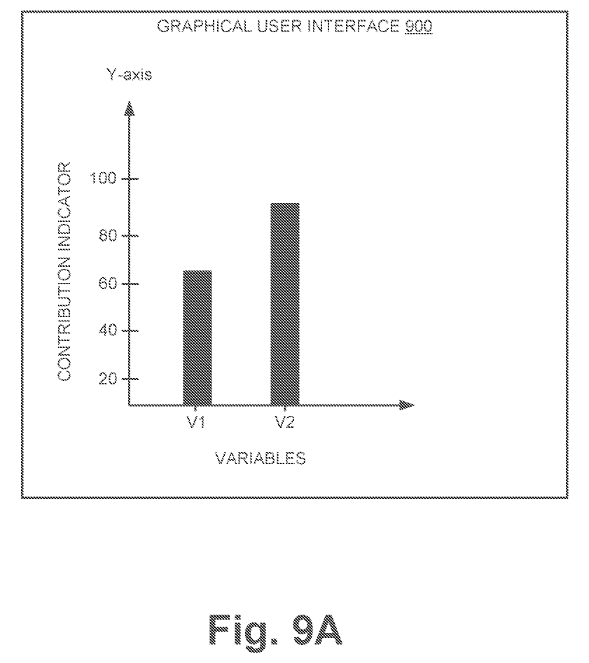

The computational model 110 may communicate the determined temporal bucket or the lead time indicated by the temporal bucket to the processor 104 or the signal generation unit 504 of the processor 104. In response to the determination of the temporal bucket, as communicated by the computational model 110, the processor 104 may generate a lead time indication signal to cause rendering of the determined temporal bucket, where the temporal bucket indicates the probable lead time to the probable deviation of the performance indicator from the threshold value prescribed for the performance indicator. In one example, the lead time indication signal may be a signal or set of commands or instructions generated by the processor 104 that may cause or trigger the rendering of the temporal bucket, such as the temporal bucket 702-4. In one example, the processor 104, or the interface generation unit 506 of the processor 104, may cause rendering of one or more graphical user interfaces to cause rendering of the probable lead time. FIGS. 8A and 8B illustrate a graphical user interface 800, according to one example implementation of the present subject matter. For example, the graphical user interface 800 may be rendered on the display device of the workstation 112 to indicate the temporal bucket (say, the temporal bucket 702-4), indicating the lead time, as illustrated in FIG. 8A. The graphical user interface 800 may also render a pattern of values of the performance indicator linked the operation 108 and determined based on the plurality of variables. In one example, the graphical user interface 800 may also render the threshold value 802. Though illustrated as a finite value, the threshold value may also be a range, similar to the historical threshold value 604-1 and 604-2 as illustrated in FIGS. 7A to 7B.

In one example, as the operation 108 may be implemented in the industrial process environment, the data source 106 may keep generating and/or storing data, or values of the plurality of variables. As the performance indicator may be determined based on the values of the variables, the performance indicator may also progress in time, as indicated in FIG. 8B. The values, and thus the tren of values, of the set of variables may also change. The computational model 110 may thus re-identify a segment (say the segment 700-5), from the segments 700, that may behaviorally correspond to the updated trend of values of the set of variables. For example, if the updated trend of values indicates increased proximity to the threshold value 802, the computational model 110 may identify a segment, say the segment 700-5, having similar behavior or characteristics. Accordingly, the computational model 110 may determine a temporal bucket (say the temporal bucket 702-5), from amongst the temporal buckets 702, for the updated trend of values. The updated temporal bucket may then be rendered on the graphical user interface 800 to indicate the updated probable lead time.

In one example, the process of reidentification of segments may be carried on by the computational model 110 until at least one segment, also referred to as a transition segment, is identified. In one example, the transition segment may indicate a transitioning series of pattern of values for the set of variables. The transition series of pattern of values indicates transitioning of the performance indicator from the probable deviation and upto a series of pattern of values of the set of variables complying with the threshold value. That is, the transitioning series of values may indicate the initial state where the performance indicator likely deviates from the threshold value, progression of values showing how the performance indicator changes, and final state where the series of values for the set of variables complies with the threshold value, indicating the operation 108 has returned to an acceptable level. Segments 700-6 and 700-7 may be examples of such transition segments, where the segment 700-6 may indicate a series of pattern of values from the probable deviation and the segment 700-7 may indicate a series of pattern of values of the set of variables upto compliance of with the threshold value.

Thus, during reidentification, if the computational model identifies that a transition segment behaviorally corresponds to the updated trend of values of the set of variables, the computational model 110 may not determine any temporal bucket or may determine a null temporal bucket. Such an implementation may be to stop further determinations of lead time as the probable deviation has occurred. Such implementation may also avoid lead time predictions during recovery time (e.g., as the tranition series indicates upto the series of pattern of values of the set of variables comply with the threshold value) of the performance indicator. Further, if the computational model 110 determines a segment, other than the transition segment, the computational model may again initiate reidentification or corresponding segments and temporal buckets for, and based on, the subsequently recorded trend of values of the set of variables.

Further, in one example, the processor 104 may determine a risk indicator for the set of variables, in response to the determination of the temporal bucket. The risk indicator, in one example, may cumulatively and quantitatively indicate a probable risk associated with the probable deviation of the performance indicator. For example, higher the values of the risk indicator, the higher may be the risk associated with the probable deviation. Numerical representation of the level of risk may allow for easier comparison and prioritization. By indicating the severity of potential deviations, it can serve as an early warning mechanism for impending issues. The risk indicator may thus reflect the severity or seriousness of the probable deviation, offering an insight into how urgently corrective action may be needed to prevent the probable deviation. It may also aid in decision-making by highlighting which variables or areas may require immediate attention or intervention.

In one example, to determine the risk indicator, the processor 104 may initially compute a contribution indicator for each variable in the set of variables. In one example, the contribution indicator, for each variable, may be determined based on the probable lead time indicated by the determined temporal bucket, an occurrence indicator, a weightage indicator, and a deviation indicator. In one example, the processor 104 may execute the computational model 110 to determine, based on the historical time-series data, at least one of the occurrence indicator and the weightage indicator for each variable in the set of variables.

In one example, the occurrence indicator may indicate a number of times a variable, from amongst the set of variables, identified as a probable cause of the probable deviation of the historical performance indicator. That is, the occurrence indicator may represent the frequency with which that variable, in the set of variables, was identified as a probable cause of historical deviations in the historical performance indicator. As discussed above, the historical time-series data may reveal the pattern of values of the historical performance indicator, and may include one or more deviations of the historical performance indicator in the past. Further, as discussed above, each of the plurality of variables (and thereby associated with the set of variables also) may have the potential contribution score associated therewith. For each of the deviations in the past, a variable that is identified as the reason or contributor for deviation (based on the causal effect, as discussed above), the occurrence indicator for that variable may be increased by 1. That is, for each historical deviation, a variable identified as a contributor to the deviation (based on its causal effect exceeding, say a prescribed or predefined threshold causal value) has its occurrence indicator incremented by 1. This process is repeated by the computational model 110 for all past deviations, resulting in a cumulative count of how often each variable was identified as a contributor. For instance, if variable V1 was identified as a contributor in two out of three past deviations based on its potential contribution score, the occurrence indicator for V1 would be set to 2 by the processor 104.

In one example, the weightage indicator, determined for each variable in the set of variables, may indicate contribution of a variable, from amongst the set of variables, in causing deviation of the historical performance indicator. In one example, the processor 104 may execute the computational model 110 to determine impact of a variable, from the set of variables, on the historical performance indicator by measuring how changes in that variable correspond to changes in the historical performance indicator. The computational model 110 or the processor 102 may accordingly assign weightage indicators to each variable, in the set of variables, based on their relative impact on the historical performance indicator. Variables with stronger relationships and larger impacts may receive higher valued weightage indicators. In one example, the weightage indicator may be the potential contribution score derived for each of the variables in the set of variables, as discussed above.

Further, the processor 104 may execute the computational model 110 to determine a deviation indicator for each variable in the set of variables. The deviation indicator may indicate a measure of deviation or drift in values of a variable based on the trend of values. In one example, the computational model 110 may be trained to compute the deviation indicator based on the historical time-series data indicating a change in pattern of values of each variable in the set of variables. For example, some of the segments, say the segments 700-1 and 700-2, may indicate a series of pattern of values of each of the variables that caused the historical performance indicator to be distanced from the historical threshold value, indicating that the probable deviation may not be close. Such segments may be referred to as normal segments, as discussed above. Thus, the normal segments capture behavior or pattern of values of each of the variables, where such pattern or the behvavior indicates that deviation of the historical performance indicator may not be near or may not even occur. The computational model 110 may be trained with such behaviors or patterns of values and categorize them as normal behavior. However, there may be other segments, for example segments 700-3 to 700-6, indicating a series of pattern of values of each of the variables that caused the historical performance indicator to either be increasingly proximate or deviate from the historical threshold value. Thus, such other segments may capture change in behavior or pattern of values of each of the variables, where the change indicates that deviation of the historical performance indicator may be near or may have occurred in past or historically (as the historical-time series data is being utilized for training the computational model 110). The computational model 110 may be trained with such behaviors or patterns of values and categorize them as deviations from the normal behavior.

When the processor 104 executes the computational model 110 to determine or compute the deviation indicator for each variable in the set of variables, the computational model 110 may analyze the trend of values of each variable in the set of values. For example, for variable V1, the computational model 110 may analyse the trend of values corresponding to the variable V1. Similarly, the computational model 110 may analyse the trend of values corresponding to each variable in the set of variables. In one example, the computational model 110 may analyze the value of a variable, indicated by the trend of values, at the time “t”. For example, for variable V1 at time “t”, if the computational model 110 determines that the behavior of the value of V1 at time “t”, indicated by the trend of values, matches with the normal behavior, the computational model 110 may determine value for the deviation indicator as zero or null. However, if the computational model 110 determines deviation or drift from the normal behavior, the computational model 110 may determine that such a drift may probably cause the performance indicator to be at least increasingly proximate to the threshold value. The computational model 110 may then determine a value for the deviation indicator for V1, thus quantifying the drift from normal behavior. For example, the value may be determined based on a measure of deviation or drift in value of V1 from the behavior or pattern of values categorized under normal behavior. Thus, the deviation indicator may indicate a measure of drift, from the normal behavior, in value of each variable in the set of variables. Further, though the above example discusses determination of deviation based on the value of a variable at time “t”, however, other implementations may also be possible. For example, as the trend of values may be a time-series data, the computational model 110 may analyze the value of the deviation indicator for a variable at all the timestamps in the time-series data, and determine an average value for the deviation indicator.

Based on the occurrence indicator, the deviation indicator, and the weighage indicator determined for each variable in the set of variables, along with the determined temporal bucket, the processor 104 may determine the contribution indicator for each variable in the set of variables. Thus, the contribution indicator may be defined, for each variable, as a function:

Based on the contribution score determined for each variable in the set of variables, the processor 104 may determine a risk indicator for the set of variables. In one example, the risk indicator may be an aggregated score or value determined based on the contribution indicator computed for each variable in the set of variables at every timestamp of the time-series data (i.e., the trend of values). For example, if the set of variables includes variables V1 and V2, the contribution indicator computed for each of the variables V1 and V2 at every timestamp may be aggregated. The aggregated score may be termed as the risk indicator or score. Thus, in one example, the risk indicator may be a numerical representation of the level of risk associated with the probable deviation considering the set of variables. In one example, the processor 104 may ascertain, based on the risk indicator, whether to generate an alert generation signal to cause rendering of an alert. The alert may comprise the risk indicator to indicate the probable risk associated with the probable deviation. For example, the processor 104 may compare the value of the risk indicator with a risk threshold value to ascertain whether an alert is to be generated. If the processor 104 determines that the risk indicator is less than the threshold value, the processor 104 may restrict generation of the alert generation signal, and thereby the alert. However, if the processor 104 determines that the risk indicator is equal to or more than the threshold value, the processor 104 may generate the alert generation signal, and thereby the alert. Thus, as the risk indicator may numerically indicate the risk associated with the deviation, an alert may only be generated when the risk is determined to be significant. Thus, for scenarios where there may be probable deviation, and the lead time may have been determined, an alert may not be generated if the risk indicator indicates that the risk associated with the deviation may not be significant.

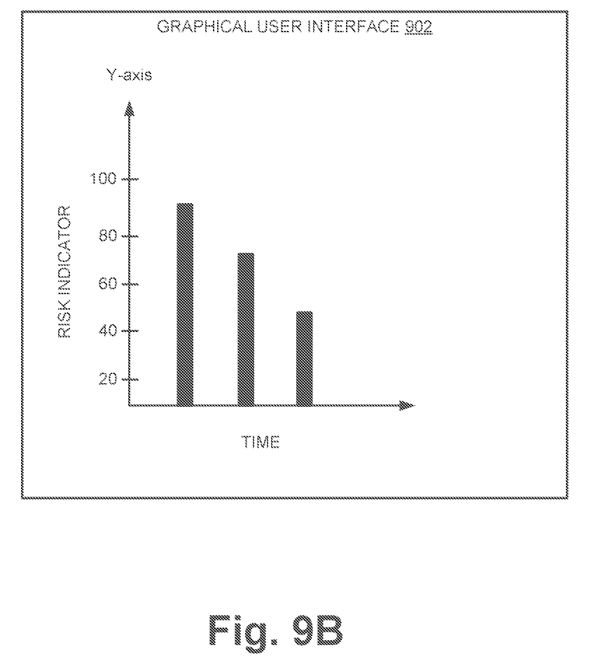

In one example, the processor 104 may also cause rendering of a graphical user interface, such as a graphical user interface 900, to render the contribution indicator computed for each variable in the set of variables. FIG. 9A illustrates the graphical user interface 900 indicating the contribution indicator determined for each variable in the set of variables, according to one example implementation of the present subject matter. As discussed above, the set of variables may include the variables V1 and V2. In one example, the graphical user interface 900 indicates the contribution indicator determined for the variables V1 and V2 in the form of a graph. However, other implementations may also be possible. For example, the graphical user interface 900 may indicate only the values of the contribution indicator determined for the variables V1 and V2.

Similarly, the processor 104 may cause rendering of another graphical user interface 902, to render the risk indicator determined for the set of variables. FIG. 9B illustrates the graphical user interface 902 indicating the risk indicator determined for the set of variables, according to one example implementation of the present subject matter. In one example, the graphical user interface 902 indicates the risk indicator determined for different timestamps in the form of a graph. However, other implementations may also be possible. For example, the graphical user interface 902 may indicate only the values of the risk indicator determined for multiple timestamps.

In another example, the processor 104 may cause rendering of the contribution indicator and the risk indicator on the graphical user interface 800, instead of rendering separate graphical user interfaces 900 and 902. Thus, the processor 104 may cause rendering of one or more graphical user interfaces to cause rendering of at least one of the probable lead time indicated by the determined temporal bucket, the contribution indicator determined for each variable in the set of variables, and the risk indicator determined for the set of variables.

Further, as the risk indicator may be determined based on the contribution indicator which is computed based on the probable lead time and the deviation indicator, the risk indicator may be updated as the probable lead time progresses towards occurrence of the probable deviation. For example, as the lead time progresses, and as the trend of value changes with progressing lead time (as the operation 108 may be implemented), the deviation indicator may also change. As a result, the processor 104 may compute the contribution indicator, and thereby the risk indicator, dynamically based on the changing lead time and the deviation indicator. For example, the changing dynamics may lead to increase in value of contribution indicator of V1 and the value of contribution indicator of V1 may become more than the contribution indicator of V2 (contrary to the previously indicated values, as illustrated in FIG. 9A). The processor 104 may accordingly cause rendering of the updated values of the contribution indicator for each of the variables in the set of variables and the risk indicator. Thus, the risk indicator, numerically representing the risk of deviation, may be updated and rendered dynamically, thereby providing updated risk estimation based on dynamically changing the trend of values of the set of variables. Further, on the basis of the contribution indicator or score, the processor 104 may rank the variables based on their impact on the risk indicator.

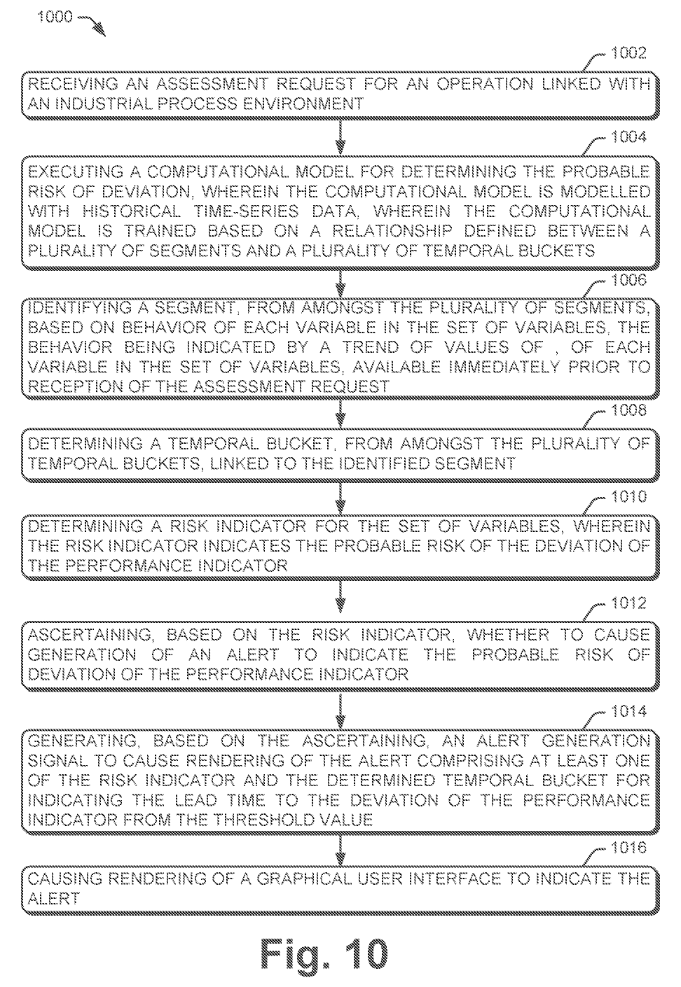

FIG. 10 illustrates a block diagram of an exemplary method 1000, for assessment of an operation linked with the industrial process environment, according to one example implementation of the present subject matter. FIG. 10 will be discussed in conjunction with FIGS. 1A to 9B. The description of FIGS. 1A to 9B has been incorporated for reference for the sake of brevity.

Further, the order in which the method 1000 is described is not intended to be construed as a limitation, and any number of the described method blocks may be combined in any order to implement the methods or alternative methods. Furthermore, the method 1000 may be implemented by processing resource(s) or computing device(s) through any suitable hardware, non-transitory machine-readable instructions, or a combination thereof.

It may also be understood that method 1000 may be performed by programmed computing device(s), such as the processor 104, as depicted in FIGS. 4 and 5. Furthermore, the method 1000 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 1000 is described below with reference to the processor 104 and the system 102 as described above; other suitable systems for the execution of these methods may also be utilized. Additionally, the implementation of the method is not limited to such examples.

At block 1002, an assessment request for an operation linked with an industrial process environment may be received. As discussed above, the operation, such as the operation 108, may have linked therewith a plurality of variables, such as the variables V1 to Vy, correlated with the operation and a performance indicator derived based on the plurality of variables. In one example, the performance indicator may quantitatively indicate an aspect related to the operation 108. Further, in one example, the assessment request may be for determining a probable risk of deviation of the performance indicator from a threshold value prescribed for the performance indicator.

At block 1004, a computational model may be executed to determine the probable risk of deviation. In one example, the computational model, such as the computational model 110, may be modelled with the historical time-series data, as discussed above. The historical time-series data may indicate a pattern of values for each variable in a set of variables identified from amongst the plurality of variables. In one example, the set of variables may be identified from amongst the plurality of variables by determining a causal effect of each variable, from amongst the plurality of variables, on the historical performance indicator, as discussed above.

Further, the computational model 110 may be trained based on a relationship defined between a plurality of segments, such as the segments 700, and the plurality of temporal buckets, such as the plurality of temporal buckets 702, as discussed above and illustrated in FIGS. 7A to 7B.

In one example, the plurality of segments, such as the segments 700-1 to 700-X (where X is a natural number), may be identified on the historical time-series data of the historical performance indicator, as illustrated in FIG. 7A. Further, as the values of the historical performance indicator may have been derived based on the underlying variables, each segment is linked to corresponding portions of the pattern of values for each of the underlying variables, as illustrated in FIG. 7B. For example, each of the segments 700 may be associated with a corresponding series or portions of the pattern of values for each variable in the set of variables. For example, segment 700-1 may be linked to the portions of V1 and V2 patterns that occurred during its timeframe and influenced the historical performance indicator's values in that segment. Segment 700-2 would be linked to the subsequent portions of V1 and V2 patterns, corresponding to its specific timeframe, and so on, as illustrated in FIG. 7B. Such linkage allows for a direct correlation between each segment of the historical performance indicator and the concurrent portions of the underlying variable’s patterns.

Further, as discussed above, one or more of the plurality of segments 700 may indicate a behavior or series of the pattern of values of the set of variables causing the historical performance indicator to be at least proximate to a probable deviation from the historical threshold value. For example, as the historical performance indicator may have deviated from the historical threshold value in the past, some of the segments, such as the segments 700-5 and 700-6, may indicate such pattern of values of the historical performance indicator, as illustrated in FIG. 7A. These segments may also correspond to a series of patterns of values of the identified set of variables, illustrated in FIG. 7B, which may be associated with the historical performance indicator being at least proximate to a probable deviation from the historical threshold value. Thus, the segments, such as the segments 700-5 and 700-6, may be indicative of a series of pattern of values of the identified set of variables, as illustrated in FIG. 7B, that may have caused the historical performance indicator to be at least proximate to a probable deviation from the historical threshold value. That is, some of the segments, such as the segment 700-5 may indicate the series of pattern of values of the set of variables that probably led the historical performance indicator to be proximate or approaching the historical threshold value, whereas the segment 700-6 may indicate the series of pattern of values of the set of variables that led the historical performance indicator to probably deviate from the historical threshold value.

Further, each of the plurality of temporal buckets 702 may indicate a probable lead time to the probable deviation of the historical performance indicator. The probable lead time may indicate a range of duration to the probable deviation of the historical performance indicator from the historical threshold value.

In one example, for being trained, the computational model 110 may be supervisedly modelled by indicating inputs (segments 700) that are mapped to outputs (temporal buckets 702). That is, the computational model 110 may be modelled using supervised learning techniques where the computational model 110 may be trained by indicating suitable output for a corresponding input.

In one example, each of the plurality of segments 700 may be linked with a temporal bucket based on a degree of proximity of the historical performance indicator with the historical threshold value. For example, a segment, from amongst the plurality of segments 700, comprising a series of pattern of values (of the set of variables) causing the historical performance indicator to be proximate to the probable deviation may be linked with a temporal bucket, from amongst the plurality of temporal buckets 702, indicating increased temporal proximity to the probable deviation, as compared to another segment comprising a series of pattern of values (of the set of variables) causing the historical performance indicator to be comparatively distanced from the probable deviation. That is, the segments containing patterns of values that indicate the historical performance indicator is approaching a deviation are mapped to temporal buckets representing shorter lead times; and segments with patterns showing the historical performance indicator far from deviation are mapped to buckets with longer lead times.

In one example, the mapping may be performed by linking the segment indicating the probable deviation of the historical performance indicator with the temporal bucket indicating least lead time to deviation or most temporal proximity to the deviation. For example, the segment 700-5 (indicating the historical performance indicator to be deviating from the historical threshold value) may be linked with the temporal bucket 702-5 representing 0-1 hours to the probable deviation. Similarly, the segment 700-4 (indicating the historical performance indicator to be deviating from the historical threshold value, but having a lower degree of proximity with the historical threshold value) may be linked with the temporal bucket 702-4 representing 1-2 hours before the probable deviation. Similarly, each of the plurality of segments 700 may be mapped or linked with the temporal buckets 702. Further, in one example, some of the segments may be mapped or linked with null temporal buckets that may not indicate any lead time, as discussed above. For example, consider some of the segments, say the segments 700-1 and 700-2, may indicate a series of pattern of values of the historical performance indicator that are distanced from the historical threshold value, indicating that the probable deviation may not be close. Such segments may not be linked with any of the temporal buckets 702 as the probable deviation may not be considerably close or as there may be a probability that the deviation may not even occur. Therefore, the computational model 110 may be configured by defining relationships between the plurality of segments 700 and the plurality of temporal buckets 702 for predicting the probable lead time. In one example, the configuration or modelling may enable the computational model 110 to predict the probable lead time to the probable deviation of the performance indicator from the threshold value, upon receiving the assessment request.

Further, in one example, the computational model 110 may be trained based on the historical time-series data through a process of iterative learning and optimization. Initially, the historical time-series data may be preprocessed to ensure data quality and consistency. This preprocessing step may involve handling missing values, normalizing data ranges, and encoding categorical variables if present in the historical time-series data. In the training phase, computational model 110, such as a neural network-based machine learning model, may be fed with the preprocessed historical time-series data, where the segments 700 serve as input features and the temporal buckets 702 as output targets. The computational model 110 may then iteratively adjust its internal parameters or weights to minimize the difference between its predictions and the actual lead time indicated in the historical time-series data. In one example, cross-validation techniques may be employed during the training process to ensure the model's generalizability. The historical time-series data may be split into training and validation sets, allowing the computational model 110 to learn from one subset of data and be evaluated on another. This approach may help ensure that the computational model 110 performs well on unseen data.

At block 1006, a segment, from amongst the plurality of segments, may be identified based on behavior of each variable in the set of variables. The behavior of each variable may be indicated by a trend of values, of each variable in the set of variables, available immediately prior to reception of the assessment request. In one example, in response to being executed and/or upon receiving the assessment request, the computational model 110 may identify the segment, from amongst the plurality of segments 700, that probably matches with the behavior or characteristics indicated by the trend of values of each variable in the set of variables at the time “t”, as discussed above. The computational model 110 may analyze the value of each variable, in the set of variables, at the time “t” and extract relevant features about the behavior of each variable in the set of variables at the time “t”. The computational model 110 may then identify a segment that may correspond or match with the behavior indicated by the values of each variable in the set of variables at the time “t”.

At block 1008, the computational model 110 may determine a temporal bucket, from amongst the plurality of temporal buckets 702, linked with the matching segment. For example, the computational model 110 may identify the segment 700-4 as the matching segment, based on the trend of values. Considering, for example, the temporal bucket 702-4 may be linked or mapped with the segment 700-4. The computational model 110 may thus determine the temporal bucket 702-4, indicating 1 to 2 hours, from the temporal buckets 702.

At block 1010, a risk indicator for the set of variables may be determined, in response to the determination of the temporal bucket. In one example, the risk indicator may indicate the probable risk of the deviation of the performance indicator from the threshold value. For example, higher the values of the risk indicator, the higher may be the risk of the probable deviation. In one example, the risk indicator may be an aggregate score computed based on a contribution score determined for each variable in the set of variables. As discussed above, the contribution score for each variable in the set of variables may be computed based on an occurrence indicator determined for that variable in the set of variables; a weightage indicator determined for that variable in the set of variables; a deviation indicator determined for that variable in the set of variables; and the probable lead time indicated by the determined temporal bucket.

In one example, the occurrence indicator may be determined for each variable in the set of variables based on the historical time-series data. The occurrence indicator may indicate, in one example, a number of times a variable, from amongst the set of variables, is identified as a probable cause of the probable deviation of the historical performance indicator. In one example, the identification may be based on the causal effect or potential contribution score associated with each of the variables In the set of variables, as discussed above. Further, the weightage indicator, determined for each variable in the set of variables, may indicate the contribution of a variable, from amongst the set of variables, in causing the probable deviation of the historical performance indicator. In one example, for each variable, its impact on the historical performance indicator may be computed by measuring how changes in the variable correspond to changes in the performance indicator. Accordingly, a weightage indicator, for example a score, may be assigned to each variable, in the set of variables, based on their relative impact on the historical performance indicator. Variables with stronger relationships and larger impacts may receive higher valued weightage indicators. In one example, the weightage indicator may be the potential contribution score derived for each of the variables in the set of variables, as discussed above.

Further, the deviation indicator may be computed for each variable in the set of variables. In one example, the deviation indicator may indicate a measure of deviation or drift in values of a variable based on the trend of values. As discussed above in one example, the computational model 110 may be trained to compute the deviation indicator based on the historical time-series data indicating a change in pattern of values of each variable in the set of variables. For example, the computational model may be trained to categorize normal segments, as discussed above, that capture behavior or pattern of values of each of the variables, where such pattern or the behvavior indicates that deviation of the historical performance indicator may not be near or may not even occur. The computational model 110 may also be trained to categorize other segments that capture change in behavior or pattern of values of each of the variables, where the change indicates that deviation of the historical performance indicator may be near or may have occurred historically. The computational model 110 may be trained with such behaviors or patterns of values and categorize them as deviations from the normal behavior.

Further, to determine or compute the deviation indicator for each variable in the set of variables, the computational model 110 may analyze the trend of values of each variable in the set of values. For example, for variable V1, the computational model 110 may analyse the trend of values corresponding to the variable V1. Similarly, the computational model 110 may analyse the trend of values corresponding to each variable in the set of variables. In one example, the computational model 110 may analyze the value of a variable, indicated by the trend of values, at the time “t”. If the computational model 110 determines that the behavior of the value of V1 at time “t”, indicated by the trend of values, matches with the normal behavior, the computational model 110 may determine value for the deviation indicator as zero or as a contant value. However, if the computational model 110 determines deviation or drift from the normal behavior, the computational model 110 may determine that such a drift may probably cause the performance indicator to be at least increasingly proximate to the threshold value. The computational model 110 may then determine a value for the deviation indicator for V1, thus quantifying the drift from normal behavior. For example, the value may be determined based on a measure of deviation or drift in value of V1 from the behavior or pattern of values categorized under normal behavior. Thus, the deviation indicator may indicate a measure of drift, from the normal behavior, in value of each variable in the set of variables. Based on an aggregate of the contribution indicator determined for each variable in the set of variables, the risk indicator may be determined for the set of variables. In one example, the risk indicator may be an aggregate numerical representation of the level of risk associated with the probable deviation considering the set of variables.

At block 1012, it may be ascertained, based on the risk indicator, whether to cause generation of an alert to indicate the probable risk of deviation of the performance indicator. For example, value of the risk indicator may be compared with a risk threshold value to ascertain whether an alert is to be generated. If it is determined that the risk indicator is less than the threshold value, generation of the alert may be prevented, and the method may flow to block 1006. However, if it is determined that the risk indicator is equal to or more than the risk threshold value, it may be ascertained that the alert is to be generated, and the method may flow to block 1014.

At block 1014, an alert generation signal may be generated to cause rendering of the alert comprising at least one of the risk indicator and the determined temporal bucket for indicating the probable lead time to the deviation of the performance indicator from the threshold value.

At block 1016, rendering of a graphical user interface may be caused in response to generation of the alert generation signal to indicate the alert comprising at least one of the probable lead time indicated by the determined temporal bucket, the contribution indicator computed for each variable in the set of variables, and the risk indicator determined for each variable.

Further, as the risk indicator may be determined based on the contribution indicator which is dependent on the probable lead time and the deviation indicator, the contribution indicator and thereby the risk indicator may be updated as the probable lead time progresses towards occurrence of the probable deviation. For example, as the lead time progresses, and as the trend of value changes with progressing lead time (as the operation 108 may be implemented), the deviation indicator may also change. As a result, the risk indicator may also dynamically modify based on the changing lead time and the deviation indicator, as also discussed above.

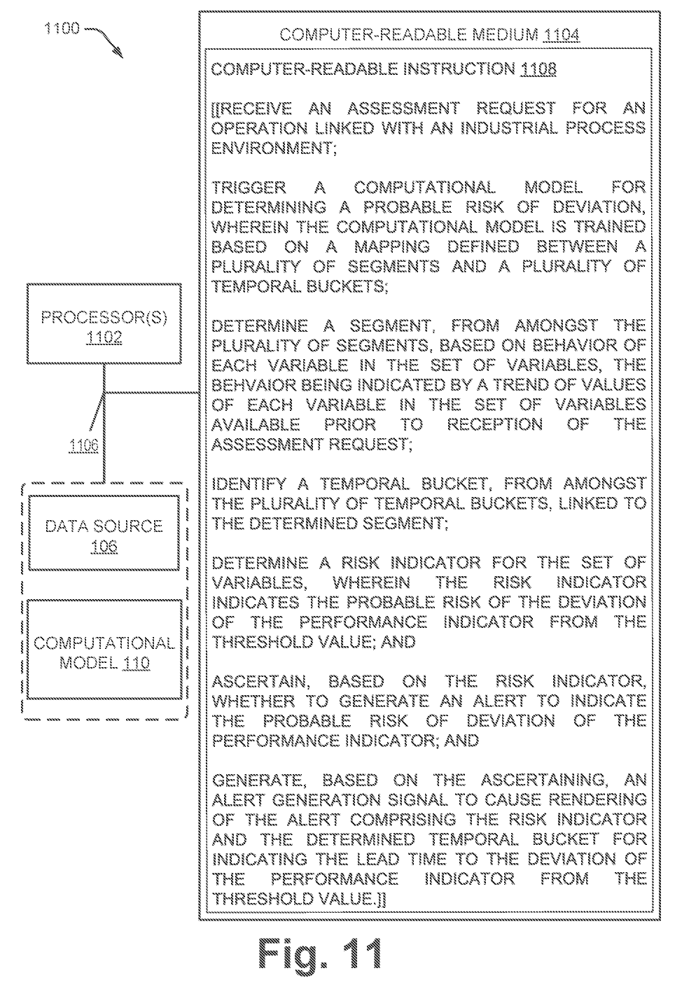

FIG. 11 illustrates a non-transitory computer-readable medium for assessment of an operation linked with the industrial process environment, in accordance with an example of the present subject matter. FIG. 11 will be discussed with reference to FIGS. 1A to 9B. The description of FIGS. 1A to 9B has been incorporated for reference for the sake of brevity.

In an example, the computing environment 1100 includes a processor 1102 communicatively coupled to a non-transitory computer-readable medium 1104 through communication link 1106. In one example, the processor 1102 may include one or more processing resources for fetching and executing computer-readable instructions from the non-transitory computer-readable medium 1104. The processor 1102 and the non-transitory computer-readable medium 1104 may be implemented, for example, in the system 102.

The non-transitory computer-readable medium 1104 may be, for example, an internal memory device or an external memory. In an example implementation, the communication link 1106 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 1104 includes a set of computer-readable instructions 1108 which may be accessed by the processor 1102 through the communication link 1106. The processor 1102 and the non-transitory computer-readable medium 1104 may also be communicatively coupled to the data source 106 and the computational model 110 over the communication link 1106.

Referring to FIG. 11, in one example, the non-transitory computer-readable medium 1104 includes computer-readable instructions 1108 that may cause the processor 1102 to receive an assessment request for an operation, such as the operation 108, linked with the industrial process environment. As discussed above, the operation 108 may have linked therewith the plurality of variables, such as the variables V1 to Vy, correlated with the operation 108 and the performance indicator derived based on the plurality of variables. In one example, the performance indicator may quantitatively indicate an aspect related to the operation 108. Further, in one example, the assessment request may be for determining a probable risk of deviation of the performance indicator from a threshold value prescribed for the performance indicator.

Further, in one example, the non-transitory computer-readable medium 1104 includes computer-readable instructions 1108 that may cause the processor 1102 to trigger the computational model 110 for determining the probable risk of deviation. In one example, the computational model may be modelled with the historical time-series data, as discussed above. The historical time-series data may indicate a pattern of values for each variable in a set of variables identified from amongst the plurality of variables, as discussed above. In one example, the computational model 110 may be trained based on a mapping defined between the plurality of segments 700, and the plurality of temporal buckets 702, as discussed above and illustrated in FIGS. 7A to 7B.

As discussed above, each segment may comprise a series of the pattern of values of each variable in the set of variables. Such series of pattern of values may indicate a behavior of values within that segment. Further, one or more of the plurality of segments 700 may comprise a series of the pattern of values causing the historical performance indicator to deviate from the historical threshold value. Further, each of the plurality of temporal buckets 702 may indicate a probable lead time to the deviation of the historical performance indicator. As discussed above, each of the plurality of segments 700 may be linked with a temporal bucket based on a degree of proximity of the historical performance indicator with the historical threshold value. For example, a segment, from amongst the plurality of segments 700, comprising a series of pattern of values (of the set of variables) causing the historical performance indicator to be proximate to the probable deviation may be linked with a temporal bucket, from amongst the plurality of temporal buckets 702, indicating increased temporal proximity to the probable deviation, as compared to another segment comprising a series of pattern of values (of the set of variables) causing the historical performance indicator to be comparatively distanced from the probable deviation. That is, the segments containing patterns of values that indicate the historical performance indicator is approaching a deviation are mapped to temporal buckets representing shorter lead times; and segments with patterns showing the historical performance indicator far from deviation are mapped to buckets with longer lead times.

Further, in one example, the non-transitory computer-readable medium 1104 includes computer-readable instructions 1108 that may cause the processor 1102 to determine a segment, from amongst the plurality of segments 700, based on behavior of each variable in the set of variables. The behavior of each variable may be indicated by a trend of values, of each variable in the set of variables, available prior to reception of the assessment request. In one example, in response to being triggered, the computational model 110 may identify the segment, from amongst the plurality of segments 700, that probably matches with the behavior indicated by the trend of values of each variable in the set of variables at the time “t”, as discussed above.

In one example, the non-transitory computer-readable medium 1104 includes computer-readable instructions 1108 that may cause the processor 1102 to determine the risk indicator for the set of variables. The risk indicator may indicate the probable risk of the deviation of the performance indicator from the threshold value. In one example, the risk indicator may be determined based on an aggregate of the contribution indicator computed for each variable in the set of variables.

As discussed above, the contribution indicator may be determined for each variable based on the probable lead time indicated by the determined temporal bucket, the occurrence indicator, the weightage indicator, and the deviation indicator. For example, the occurrence indicator and the weightage indicator for each variable in the set of variables may be determined based on the historical time-series data. In one example, the occurrence indicator may indicate a number of times a variable, from amongst the set of variables, is identified as a probable cause of the probable deviation of the historical performance indicator. In one example, the identification may be based on the causal effect or potential contribution score associated with each of the variables In the set of variables, as discussed above. Further, the weightage indicator, determined for each variable in the set of variables, may indicate the contribution of a variable, from amongst the set of variables, in causing the probable deviation of the historical performance indicator, as discussed above. Further, the deviation indicator may be computed for each variable in the set of variables. The deviation indicator may indicate a measure of deviation or drift in the values of each variable in the set of variables, as discussed above.

Further, in one example, the non-transitory computer-readable medium 1104 includes computer-readable instructions 1108 that may cause the processor 1102 to ascertain, based on the risk indicator, whether to cause generation of an alert to indicate the probable risk of deviation of the performance indicator. In one example, the ascertaining may be based on a comparison between the value of the risk indicator and the risk threshold value, as discussed above.

Further, in one example, the non-transitory computer-readable medium 1104 includes computer-readable instructions 1108 that may cause the processor 1102 to generate, based on the ascertaining, an alert generation signal to cause rendering of the alert comprising the risk indicator and the determined temporal bucket for indicating the probable lead time to the deviation of the performance indicator from the threshold value. As discussed above, rendering of a graphical user interface may be caused in response to generation of the alert generation signal to indicate the probable lead time indicated by the determined temporal bucket and the risk indicator determined for the set of variables.

Further, the plurality of segments 700 of the historical time-series data may comprise a transition segment indicating a transition series of pattern of values for the set of variables. The transition series of pattern of values indicates the transitioning of the performance indicator from the probable deviation and upto a series of pattern of values of the set of variables complying with the threshold value. That is, the transition series of values may indicate the initial state where the performance indicator likely deviates from the threshold value, progression of values showing how the performance indicator changes, and final state where the series of values for the set of variables complies with the threshold value, indicating the operation 108 has returned to an acceptable level. Segments 700-6 and 700-7 may be examples of such transition segments, where the segment 700-6 may indicate a series of pattern of values from the probable deviation and the segment 700-7 may indicate a series of pattern of values of the set of variables upto compliance of with the threshold value, as discussed above. Thus, upon being triggered, if the computational model identifies that a transition segment corresponds to the updated trend of values of the set of variables, the computational model 110 may not determine any temporal bucket or may determine a null temporal bucket. Such an implementation may be to stop further determinations of lead time as the probable deviation has already occurred. Such implementation may also avoid lead time predictions and risk determination. Further, if the computational model 110 determines a segment, other than the transition segment, the computational model may again initiate reidentification or corresponding segments and temporal buckets for, and based on, the subsequently recorded trend of values of the set of variables.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
receive an assessment request for an operation linked with an industrial process environment, the operation having linked therewith a plurality of variables and a performance indicator derived based on the plurality of variables, and wherein the assessment request is for predicting a probable lead time to a probable deviation of the performance indicator from a threshold value prescribed for the performance indicator;
execute, in response to receiving the assessment request, a computational model capable of predicting the probable lead time, wherein the computational model is modelled with historical time-series data for predicting the probable lead time, the historical time-series data indicating a pattern of values for each variable in a set of variables identified from amongst the plurality of variables, wherein the computational model is modelled based on a relationship between:
a plurality of segments of the historical time-series data, wherein each segment indicates a series of the pattern of values of each variable in the set of variables, and wherein one or more of the plurality of segments indicate a series of the pattern of values causing a historical performance indicator to be at least proximate to a probable deviation from a historical threshold value; and
a plurality of temporal buckets, each indicating a probable lead time to the probable deviation of the historical performance indicator, wherein each of the plurality of segments is linked with a temporal bucket based on a degree of proximity of the historical performance indicator with the historical threshold value,
wherein the computational model, in response to being executed, is to:
identify a segment, from amongst the plurality of segments, based on behavior of each variable in the set of variables, the behavior being indicated by a trend of values of each variable in the set of variables recorded immediately prior to reception of the assessment request; and
determine a temporal bucket, from amongst the plurality of temporal buckets, linked to the identified segment; and
generate, in response to the determination of the temporal bucket, a lead time indication signal to cause rendering of the determined temporal bucket, wherein the temporal bucket indicates the probable lead time to the probable deviation of the performance indicator from the threshold value prescribed for the performance indicator.

2. The system of claim 1, wherein each plurality of temporal buckets indicates a unique probable lead time, and wherein the probable lead time indicates a range of duration to the probable deviation of the historical performance indicator from the threshold value prescribed for the historical performance indicator.

3. The system of claim 1, wherein a segment, from amongst the plurality of segments, comprising a series of pattern of values causing the historical performance indicator to be proximate to the probable deviation is linked with a temporal bucket, from amongst the plurality of temporal buckets, indicating increased temporal proximity to the probable deviation, as compared to another segment comprising a series of pattern of values causing the historical performance indicator to be comparatively distanced from the probable deviation.

4. The system of claim 1, wherein the processor is to execute the computational model to determine, based on the historical time-series data, at least one of:
an occurrence indicator for each variable in the set of variables, the occurrence indicator indicating a number of times a variable, from amongst the set of variables, identified as a probable cause of the probable deviation of the historical performance indicator, the identification being based on a causal effect of a variable, in the set of variables, on the historical performance indicator; and
a weightage indicator for each variable in the set of variables, the weightage indicator indicating contribution of a variable, from amongst the set of variables, in causing deviation of the historical performance indicator.

5. The system of claim 4, wherein the processor is to execute the computational model to determine a deviation indicator for each variable in the set of variables based on the behavior of each variable indicated by the trend of values, the deviation indicator indicating a measure of drift in value of that variable based on the trend of values, wherein the drift is to probably cause the performance indicator to be increasingly proximate to the threshold value, and
wherein the computational model is trained to compute the deviation indicator based on the historical time-series data indicating a change in the pattern of values of each variable in the set of variables, wherein the change historically caused the performance indicator to be increasingly proximate to the historical threshold value.

6. The system of claim 5, wherein the processor is to:
determine, in response to the determination of the temporal bucket, a contribution indicator for each variable, in the set of variables, based on:
the occurrence indicator determined for that variable;
the weightage indicator determined for that variable;
the deviation indicator determined for that variable; and
the probable lead time indicated by the determined temporal bucket;
determine, based on the contribution indicator determined for each variable in the set of variables, a risk indicator for the set of variables, wherein the risk indicator quantitatively indicates a probable risk associated with the probable deviation of the performance indicator;
ascertain, based on the risk indicator, whether to generate an alert generation signal to cause rendering of an alert, wherein the alert comprises the risk indicator to indicate the probable risk associated with the probable deviation; and
generate, based on the ascertaining, the alert generation signal to cause rendering of the alert.

7. The system of claim 6, wherein the processor is to cause rendering of one or more graphical user interfaces to cause rendering of at least one of the probable lead time indicated by the determined temporal bucket, the contribution indicator determined for each variable in the set of variables, and the risk indicator determined for the set of variables.

8. The system of claim 6, wherein the risk indicator is to be updated, by the processor, as the probable lead time progresses towards occurrence of the probable deviation.

9. The system of claim 1, wherein the processor is to identify the set of variables from amongst the plurality of variables by determining a causal effect of each variable, from amongst the plurality of variables, on the historical performance indicator.

10. The system of claim 1, wherein the plurality of variables are correlated with input and output characteristics of the operation linked with the industrial process environment, and wherein the performance indicator indicates an aspect related to the operation.

11. A method comprising:
receiving an assessment request for an operation linked with an industrial process environment, the operation having linked therewith:
a plurality of variables correlated with the operation; and
a performance indicator derived based on the plurality of variables, the performance indicator quantitatively indicating an aspect related to the operation, and wherein the assessment request is for determining a probable risk of deviation of the performance indicator from a threshold value prescribed for the performance indicator;
executing a computational model for determining the probable risk of deviation, wherein the computational model is modelled with historical time-series data indicating a pattern of values for each variable in a set of variables identified from amongst the plurality of variables, wherein the computational model is trained based on a relationship defined between:
a plurality of segments of the historical time-series data, wherein each segment comprises a temporally synchronised series of the pattern of values of each variable in the set of variables, and wherein one or more of the plurality of segments comprise a series of the pattern of values causing a historical performance indicator to deviate from a historical threshold value; and
a plurality of temporal buckets, each indicating a probable lead time to the deviation of the historical performance indicator, wherein each of the plurality of segments is linked with a temporal bucket based on a degree of proximity of the historical performance indicator with the historical threshold value,
wherein the computational model, in response to being executed, is to:
identify a segment, from amongst the plurality of segments, based on behavior of each variable in the set of variables, the behavior being indicated by a trend of values, of each variable in the set of variables, available immediately prior to reception of the assessment request; and
determine a temporal bucket, from amongst the plurality of temporal buckets, linked to the identified segment;
determining, in response to the determination of the temporal bucket, a risk indicator for the set of variables, wherein the risk indicator indicates the probable risk of the deviation of the performance indicator from the threshold value;
ascertaining, based on the risk indicator, whether to cause generation of an alert to indicate the probable risk of deviation of the performance indicator; and
generating, based on the ascertaining, an alert generation signal to cause rendering of the alert comprising at least one of the risk indicator and the determined temporal bucket for indicating the probable lead time to the deviation of the performance indicator from the threshold value.

12. The method of claim 11, wherein segments, from amongst the plurality of segments, causing the performance indicator to be proximate to the historical threshold value are linked with a temporal bucket indicating a lesser probable lead time to the deviation, as compared to other segments causing the performance indicator to be comparatively distanced from the historical threshold value, wherein the other segments are linked with a temporal bucket indicating a comparatively more probable lead time to the deviation.

13. The method of claim 11, the method further comprising:
determining, based on the historical time-series data, an occurrence indicator for each variable in the set of variables, the occurrence indicator indicating a number of times a variable, from amongst the set of variables, is identified as a probable cause of the probable deviation of the performance indicator from the historical threshold value, the identification being based on a causal effect of a variable, in the set of variables, on the historical performance indicator; and
determining, based on the historical time-series data, a weightage indicator for each variable in the set of variables, the weightage indicator indicating contribution of a variable, from amongst the set of variables, in causing the probable deviation of the historical performance indicator; and
compute a deviation indicator for each variable in the set of variables based on the behavior of each variable indicated by the trend of values, the deviation indicator indicating a measure of drift in value of that variable based on the trend of values, wherein the drift is to probably cause the performance indicator to be increasingly proximate to the threshold value, and wherein the computational model is trained to compute the deviation indicator based on the historical time-series data indicating a change in the pattern of values of each variable in the set of variables, wherein the change historically caused the performance indicator to be increasingly proximate to the historical threshold value.

14. The method of claim 13, wherein the risk indicator, for the set of variables, is determined based on a contribution indicator computed for each variable in the set of variables, wherein the contribution indicator for each variable is computed based on:
the occurrence indicator determined for that variable;
the weightage indicator determined for that variable;
the deviation indicator determined for that variable; and
the probable lead time indicated by the determined temporal bucket.

15. The method of claim 11, the method further comprises causing rendering of a graphical user interface to indicate the alert comprising at least one of the probable lead time indicated by the determined temporal bucket, the contribution indicator computed for each variable in the set of variables, and the risk indicator determined for the set of variables.

16. The method of claim 11, the method further comprises identifying the set of variables from amongst the plurality of variables by determining a causal effect of each variable, from amongst the plurality of variables, on the historical performance indicator.

17. A non-transitory computer-readable medium comprising instructions, the instructions being executable by a processing resource to:
receive an assessment request for an operation linked with an industrial process environment, the operation having linked therewith:
a plurality of variables correlated with the operation; and
a performance indicator derived based on the plurality of variables, the performance indicator quantitatively indicating an aspect related to the operation, and wherein the assessment request is for determining a probable risk of deviation of the performance indicator from a threshold value prescribed for the performance indicator;
trigger a computational model for determining the probable risk of deviation, wherein the computational model is modelled with historical time-series data indicating a pattern of values for each variable in a set of variables identified from amongst the plurality of variables, wherein the computational model is trained based on a mapping defined between:
a plurality of segments of the historical time-series data, wherein each segment comprises a series of the pattern of values of each variable in the set of variables, and wherein one or more of the plurality of segments comprise a series of the pattern of values causing a historical performance indicator to deviate from a historical threshold value; and
a plurality of temporal buckets, each indicating a probable lead time to the deviation of the historical performance indicator, wherein each of the plurality of segments is linked with a temporal bucket based on a degree of proximity of the historical performance indicator with the historical threshold value,
wherein the computational model, in response to being triggered, is to:
determine a segment, from amongst the plurality of segments, based on behavior of each variable in the set of variables, the behavior being indicated by a trend of values of each variable in the set of variables available prior to reception of the assessment request; and
identify a temporal bucket, from amongst the plurality of temporal buckets, linked to the determined segment;
determine a risk indicator for the set of variables, wherein the risk indicator indicates the probable risk of the deviation of the performance indicator from the threshold value;
ascertain, based on the risk indicator, whether to generate an alert to indicate the probable risk of deviation of the performance indicator; and
generate, based on the ascertaining, an alert generation signal to cause rendering of the alert comprising the risk indicator and the determined temporal bucket for indicating the probable lead time to the deviation of the performance indicator from the threshold value.

18. The non-transitory computer-readable medium of claim 17, wherein the processing resource is to:
determine, based on the historical time-series data, an occurrence indicator for each variable in the set of variables, the occurrence indicator indicating a number of times a variable, from amongst the set of variables, is identified as a probable cause of the probable deviation of the historical performance indicator from the historical threshold value, the identification being based on a causal effect of a variable, in the set of variables, on the historical performance indicator;
determine, based on the historical time-series data, a weightage indicator for each variable in the set of variables, the weightage indicator indicating contribution of a variable, from amongst the set of variables, in causing deviation of the historical performance indicator; and
determine a deviation indicator for each variable in the set of variables based on the behavior of each variable indicated by the trend of values, the deviation indicator indicating a measure of drift in value of that variable based on the trend of values, wherein the drift is to probably cause the performance indicator to be increasingly proximate to the threshold value, and wherein the computational model is trained to compute the deviation indicator based on the historical time-series data indicating a change in the pattern of values of each variable in the set of variables, wherein the change historically caused the performance indicator to be increasingly proximate to the historical threshold value.

19. The non-transitory computer-readable medium of claim 18, wherein the processing resource is to determine the risk indicator for the set of variables based on a contribution indicator determined for each variable in the set of variables, wherein the contribution indicator is determined for each variable based on:
the occurrence indicator determined for that variable;
the weightage indicator determined for that variable;
the deviation indicator determined for that variable; and
the probable lead time indicated by the determined temporal bucket.

20. The non-transitory computer-readable medium of claim 17, wherein the plurality of segments of the historical time-series data comprise a transition segment indicating a transition series of pattern of values for the set of variables, the transition series of pattern of values indicating transitioning of the performance indicator from the probable deviation and upto a series of pattern of values of the set of variables complying with the threshold value.
